(19) United States
(12) Patent Application Publication
(10) Pub. No.: US 2024/0322532 A1
(43) Pub. Date: Sep. 26, 2024

(54) TRANSMISSION LINE ADVANCEMENT SYSTEM INCLUDING A TRANSMISSION LINE SENSOR

(71) Applicant: Condux International, Inc., Mankato, MN (US)

(72) Inventors: Bradley Paul Radichel, Key Largo, FL (US); Heinz U. Wortmann, Lino Lakes, MN (US); David J. Hassing, Mankato, MN (US)

(73) Assignee: Condux International, Inc., Mankato, MN (US)

(21) Appl. No.: 18/611,583

(22) Filed: Mar. 20, 2024

Related U.S. Application Data
(60) Provisional application No. 63/491,115, filed on Mar. 20, 2023.

(51) Int. Cl. H02G 1/08; B65H 49/18; B65H 51/32; G02B 6/52

(52) U.S. Cl. CPC H02G 1/08; B65H 49/18; B65H 51/32; G02B 6/52; B65H 2513/10; B65H 2553/412; B65H 2701/32; B65H 2701/34

(57) ABSTRACT

The present disclosure relates to the installation of transmission lines with a transmission line advancement system. The transmission line advancement system is configured to install a variety of transmission lines into a conduit, pipe, duct, or the like, including fiber optic cables and electrical transmission lines. In embodiments of the disclosure an advancement device for advancing a transmission line within a transmission line installation system, a method for advancing a transmission line using an advancement device, and another advancement device for advancing a transmission line within a transmission line installation system are disclosed.

### CROSS-REFERENCE TO RELATED APPLICATION(S)

This application claims priority to U.S. Provisional Patent Application No. 63/491,115, filed on Mar. 20, 2023, the disclosure of which is hereby incorporated by reference in its entirety.

### BACKGROUND

Transmission lines are used for transmitting power or data signals. One type of transmission line is a fiber optic cable that can be used to transmit digital data using light signals. The use of fiber optic cable for data transmission is popular, at least in part due to the high data transmission rate and very fast transmission speed. Another type of transmission line is an electrical transmission line. Electrical transmission lines carry electrical current from one point to another in an electric power system.

Transmission lines can be used to carry power or data signals short distances, such as within a building, or long distances, such as between neighboring cities. For longer distance communication, cables may be installed in underground ducts, where continuous cables are desired between manhole, hand hole, or other access point locations. The underground ducts often change direction along a transmission path.

Installation equipment such as line blowers and pullers have been developed that can be used to insert fiber optic cable into ducts over long distances. It is desirable to have transmission line installation equipment which can facilitate smooth and stable advancement of a variety of transmission lines that are being installed. Furthermore, it is desirable to effectively advance a variety of transmission lines over long distances.

### SUMMARY

The present disclosure relates to the installation of transmission lines with a transmission line advancement system. The transmission line advancement system is configured to install a variety of transmission lines into a conduit, pipe, duct, or the like, including fiber optic cables and electrical transmission lines. Various aspects are described in this disclosure, which include, but are not limited to, the following aspects.

Furthermore, an example of the present disclosure relates to an advancement device for advancing a transmission line within a transmission line installation system including a local controller operable to locally control the advancement device. The local controller includes a processing device, a computer-readable storage device, and a communication device. The advancement device further includes an advancement device drive assembly operably coupled to the local controller, the advancement device drive assembly configured to receive the transmission line from a transmission line source and advance the transmission line from an inlet to a line blower assembly. The advancement device still further includes the line blower assembly operably coupled to the local controller, the line blower assembly configured to receive the transmission line from the advancement device drive assembly and advance the transmission line to an outlet. The advancement device further yet includes a transmission line sensor configured to sense a presence of the transmission line, wherein the local controller is configured to instruct the advancement device drive assembly to frictionally engage the advancement device drive assembly with the transmission line when the transmission line sensor senses the presence of the transmission line.

Further yet, another example of the present disclosure relates to a method for advancing a transmission line using an advancement device including, using a transmission line source, providing a transmission line to the advancement device at an inlet positioned at a first end of the advancement device. The method further includes using the inlet, receiving the transmission line and guiding the transmission line to a transmission line sensor. The method still further includes using the transmission line sensor, sensing the transmission line at a position downstream of an advancement device drive assembly. The method further yet includes using a local controller operably coupled to the advancement device drive assembly and the transmission line sensor, communicating the presence of the transmission line at the transmission line to an actuator configured to frictionally engage the advancement device drive assembly with the transmission line to advance the transmission line. The method also includes using the advancement device drive assembly, advancing the transmission line toward an outlet positioned at the second end of the advancement device.

Still further yet, an example of the present disclosure relates to an advancement device for advancing a transmission line within a transmission line installation system including a local controller operable to locally control the advancement device, the local controller including a processing device, a computer-readable storage device, and a communication device. The advancement device also includes the advancement device drive assembly operably coupled to the local controller, the advancement device drive assembly configured to receive the transmission line from a transmission line source and advance the transmission line from an inlet to a line blower. The advancement device drive assembly is configured to advance the transmission line by frictionally engaging the transmission line with a tractor drive. The tractor drive is configured to frictionally engage the transmission line using an actuator. The line blower assembly is operably coupled to the local controller and configured to receive the transmission line from the advancement device drive assembly and advance the transmission line to an outlet. The line blower assembly includes a means for sensing the transmission line at a point downstream of the advancement device drive assembly. The local controller is configured to instruct the advancement device drive assembly to frictionally engage the tractor drive with the transmission line when the means for sensing the transmission line senses the presence of the transmission line at the point downstream of the advancement device drive assembly.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the examples disclosed herein are based.

### BRIEF DESCRIPTION OF THE DRAWINGS

The following drawings are illustrative of examples of the present disclosure and therefore do not limit the scope of the present disclosure. Examples of the present disclosure will hereinafter be described in conjunction with the appended drawings, wherein like numerals denote like elements.

FIG. 1 is a schematic diagram illustrating an example transmission line installation system including advancement devices having an actuator and a transmission line sensor.

FIG. 2 is a block diagram of the example advancement device within the transmission line installation system of FIG. 1.

FIG. 3 is a block diagram of the example advancement device of FIGS. 1-2, including an advancement device drive assembly having tractor drives and an actuator including power lines and a proximity switch.

FIG. 4 is a block diagram of an example initial advancement device within the transmission line installation system of FIGS. 1-2.

FIG. 5 is a cross-sectional view of the example initial advancement device within the transmission line installation system of FIGS. 1-2.

FIG. 6 is a block diagram of an advancement device, and specifically a subsequent advancement device, within the transmission line installation system of FIGS. 1-2.

FIG. 7 is a cross-sectional view of the example subsequent advancement device of FIG. 6 further illustrating various components within the advancement device.

FIG. 8 is a block diagram of the example advancement device of FIG. 2, including a transmission line having optical markings.

FIG. 9 is a side view of an advancement device illustrating the components of FIGS. 1-8.

FIG. 10 is a schematic block diagram illustrating a control unit configured to communicate with at least one local controller to implement various control systems.

FIG. 11 is a schematic block diagram illustrating another example of the local controller of a component of the transmission line installation system.

FIG. 12 is a schematic block diagram illustrating an example of a control unit of a transmission line installation system.

FIG. 13 is a flow chart illustrating a method for advancing a transmission line using an advancement device.

FIG. 14 is a side view of an example advancement device including a speed measurement device, wherein the speed measurement device is in an extended position.

FIG. 15 is a side view of an example advancement device including a speed measurement device, wherein the speed measurement device is in a shortened position.

FIG. 16 is a side view of an example advancement device including a speed measurement device, wherein the speed measurement device is in an optimal position.

FIG. 17 is a side view of an example advancement device at a cascade junction, including various components for advancing a transmission line through the cascade junction.

FIG. 18 is an example connector that is configured to be used within the cascade junction of FIG. 17.

FIG. 19 is a block diagram illustrating various components of the advancement device and optional components including a continuous air feed and a compressor.

FIG. 20 is a side view illustrating the components of FIG. 19, including the continuous air feed and a compressor.

### DETAILED DESCRIPTION

Various examples will be described in detail with reference to the drawings, wherein like reference numerals represent like parts and assemblies throughout the several views.

The present disclosure relates to a transmission line installation system, which can be used to install a transmission line. The term “transmission line” is used herein as a generic term for any type of wire, cable, or other elongate structure capable of transmitting energy, whether in the form of a fiber optic cable, power line, electrical cable, telephone line (copper line), coaxial cable, or the like. In typical embodiments the transmission line installation system is configured to install a transmission line within a conduit. In embodiments, a conduit may be a broad term such that a duct may be an example of a conduit. Additionally, a transmission line installation system can also be used for other purposes, such as for installing a pull tape or other pull line, a duct, or other items within a conduit.

Although the term “transmission line” is sometimes used (such as in radio-frequency engineering) to refer to a specific type of line used to carry radio frequency signals, the term “transmission line” is not intended to be so limited in the present disclosure, but rather is intended to broadly include the transmission of any type of energy or signal (electricity, radio frequency, light, etc.) along an elongate and flexible structure. Specifically, examples of transmission lines include those that can transmit electricity, such as a wire; or light, such as a fiber optic cable including optical fibers.

Although references herein are made to a duct, the installation of a duct is not required to install a transmission line. Transmission lines may be optionally installed within a duct to divide a larger conduit into smaller subsections. Therefore, other components that are used to install or mount a duct within a conduit are also not required but may be optionally included within the transmission line installation system. Furthermore, a duct or conduit may optionally include a casing for housing the duct or conduit below the ground.

An advancement speed of the transmission line may be adjusted at access points by an advancement device providing an advancement force on the transmission line to accelerate the transmission line. The advancement device provides the advancement force at the advancement device drive assembly. In some embodiments, the advancement device drive assembly includes a pair of opposing upper and lower tractor drives that are configured to frictionally engage the transmission line. The upper and lower tractor drives may either frictionally engage, or disengage from, the transmission line using an actuator. In some embodiments, the actuator is a clamp cylinder. In some embodiments, the advancement device a transmission line sensor positioned downstream of the actuator. The transmission line sensor is configured to sense the transmission line as it passes through the advancement device at a point downstream of the actuator. In some embodiments, the transmission line enters the advancement device at an inlet, where it is then guided through the advancement device drive assembly toward an outlet. As the transmission line is guided toward the outlet, it passes a transmission line sensor that is configured to sense the presence of the transmission line within the advancement device and provide feedback to the advancement device drive assembly via a local controller. Once the advancement device drive assembly receives feedback from the transmission line sensor, it engages the actuator to operably adjust the positioning of the tractor drives to frictionally engage the transmission line. In some embodiments, the transmission line sensor is configured to determine an advancement speed of the transmission line as it passes through the advancement device. In some embodiments, the advancement speed of the transmission line at multiple advancement devices may be communicated to a global controller using a local controller at each advancement device, wherein the global controller may provide feedback to each local controller to adjust the advancement speed at each advancement device to a synchronized advancement speed. The advancement device, including the advancement device drive assembly, actuator, transmission line sensor, local controller, and global controller are discussed herein in further detail.

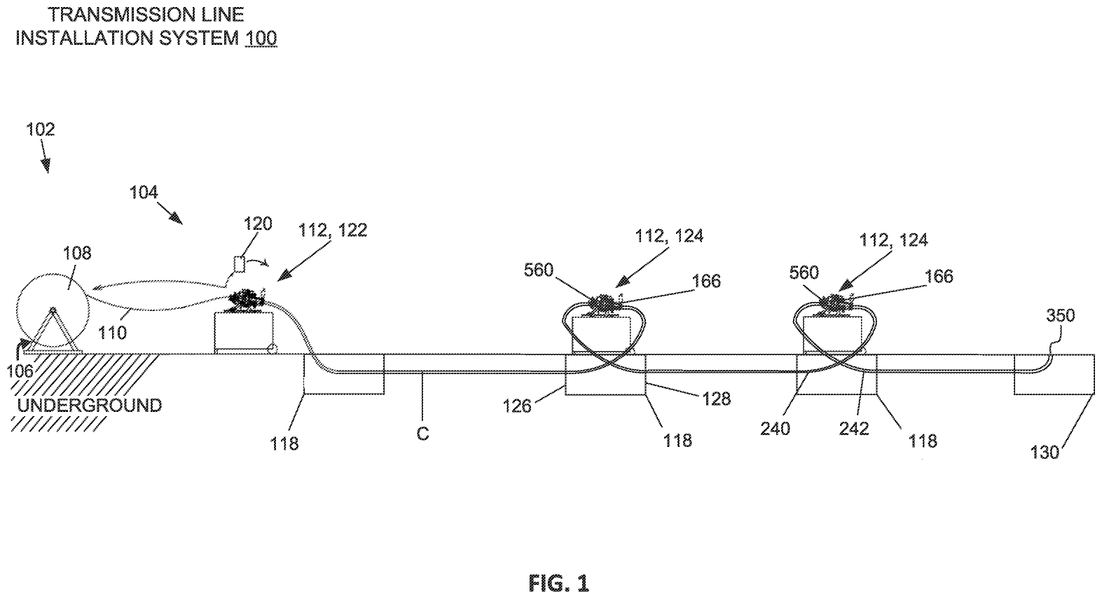

FIG. 1 is a schematic diagram illustrating an example transmission line installation system 100 being used to install a transmission line 110 at a site. In the illustrated example, the transmission line installation system 100 includes a transmission line source 102 and a transmission line conveying system 104. The example transmission line source 102 includes a reel stand 106 for holding a transmission line reel 108 containing a transmission line 110 (alternatively referred to herein as a transmission cable). The example transmission line conveying system 104 includes an advancement device 112 for advancing the transmission line 110 at an access point 118.

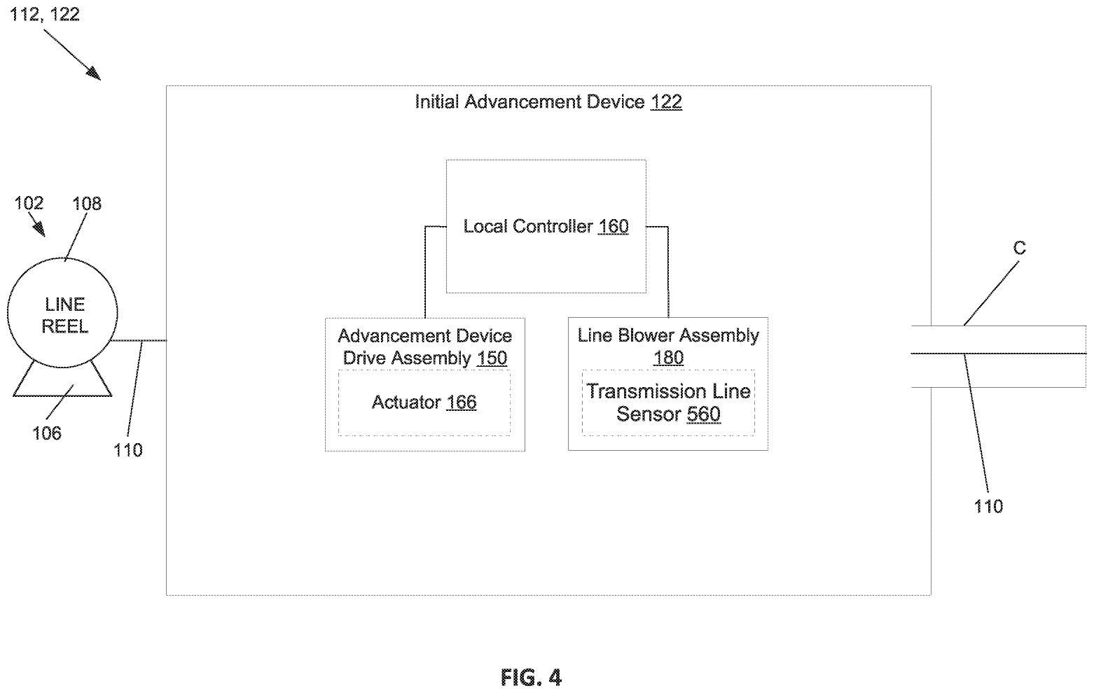

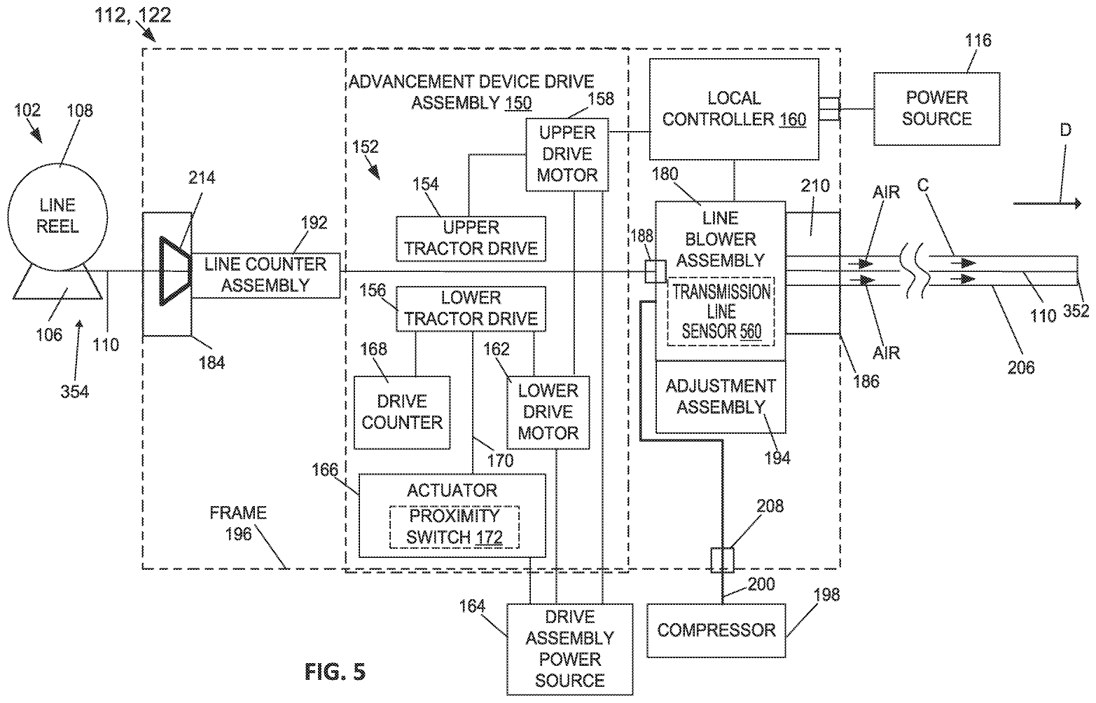

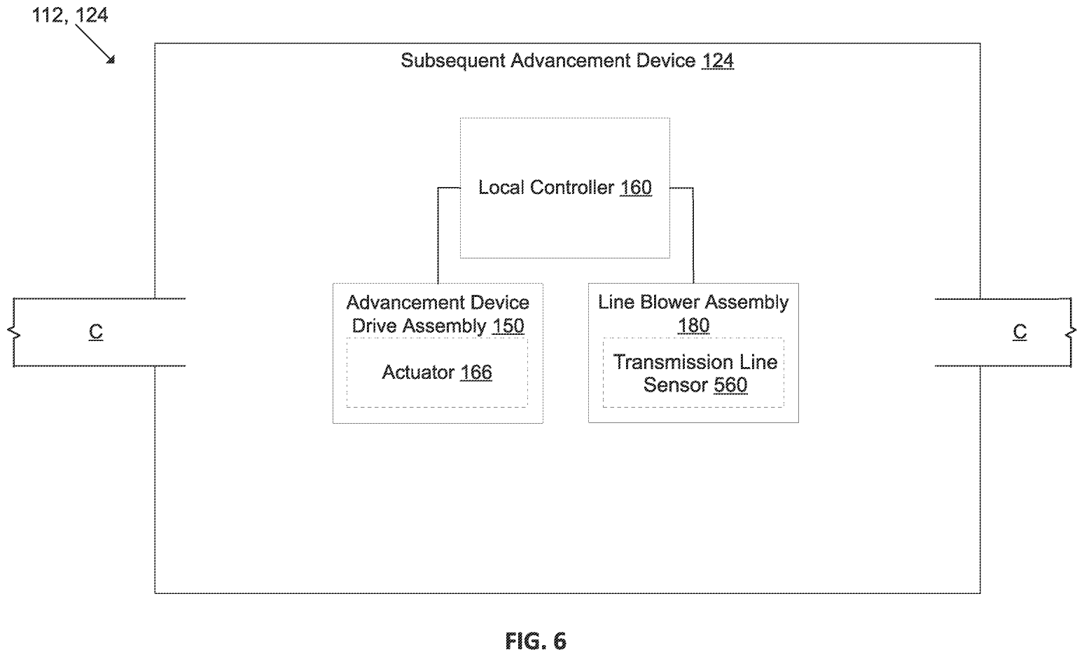

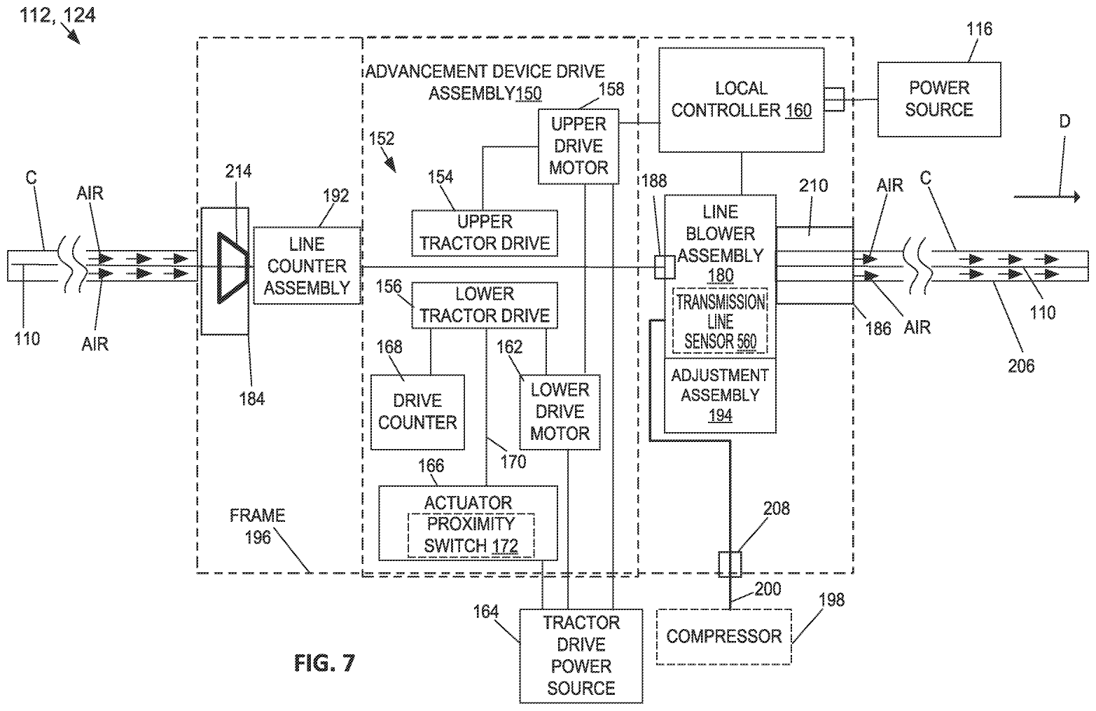

Furthermore, the transmission line installation system 100 includes a conduit C for receiving the transmission line 110 and guiding the transmission line 110 from one access point 118 to another access point 118. In some embodiments, the conduit C is positioned above the ground. In embodiments, the conduit C consists of multiple components that are connected to form one continuous conduit C, such as C1, C2, C3, etc. In some embodiments, the transmission line source 102 can be an advancement device 112 that provides a transmission line 110 to a downstream subsequent advancement device 124 within the transmission line installation system 100. As used herein, upstream may mean closer to the transmission line source 102 and downstream may mean farther from the transmission line source 102. An upstream advancement device 112 can include an initial advancement device 122 or a subsequent advancement device 124. The initial advancement device 122 is configured to receive a transmission line 110 from a transmission line source 102 such as a reel stand 106. A subsequent advancement device 124 is configured to receive a transmission line 110 from an initial advancement device 122 or an upstream subsequent advancement device 124 within a transmission line installation system 100. An example initial advancement device 122 is described in further detail with reference to FIGS. 4-5. An example subsequent advancement device 124 is described in further detail with reference to FIGS. 6-7.

The transmission line conveying system 104 is a machine that operates to install a transmission line 110 into the conduit C. Examples of transmission line conveying systems 104 include advancement devices 112 such as line puller systems, line pusher systems, line blowing systems, or systems that function the same. The example shown in FIG. 1 shows an advancement device 112 including an advancement device drive assembly 150 (not shown) configured to push or pull a transmission line 110 as well as a line blower assembly 180 (not shown) configured to advance a transmission line 110 using pressurized fluid.

In some embodiments a transmission line conveying system 104 includes a combination of one or more line pushers and one or more other types of advancement devices 112. Additionally, in some embodiments an advancement device 112 includes a line puller, and in some embodiments a line puller system includes a line blower. The transmission line conveying system 104 can also include one or more other types of transmission line advancement devices 112, alone or in combination.

The reel stand 106 supports a transmission line reel 108 configured to store, dispense, and retract a transmission line 110. In certain embodiments, the transmission line reel 108 may contain a large distance of transmission line of at least 10,000 feet.

The advancement device 112 includes a plurality of components configured to advance a transmission line 110 through a conduit C. In some embodiments, the transmission line installation system 100 can include a plurality of advancement devices 112 as shown. In some embodiments, the advancement device 112 can be either an initial advancement device 122 or a subsequent advancement device 124.

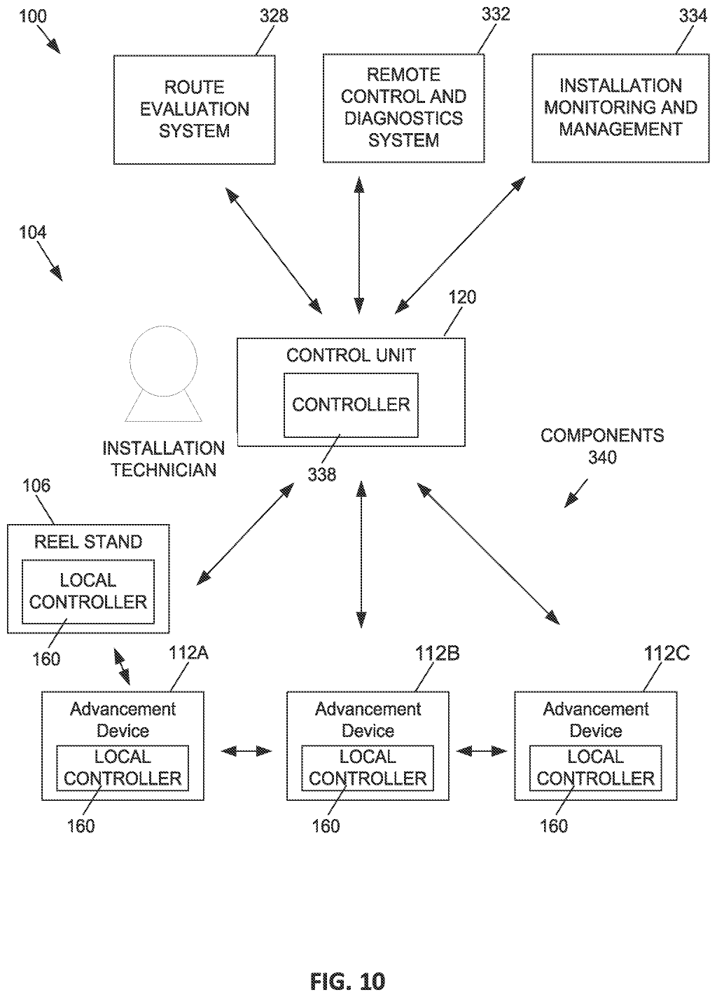

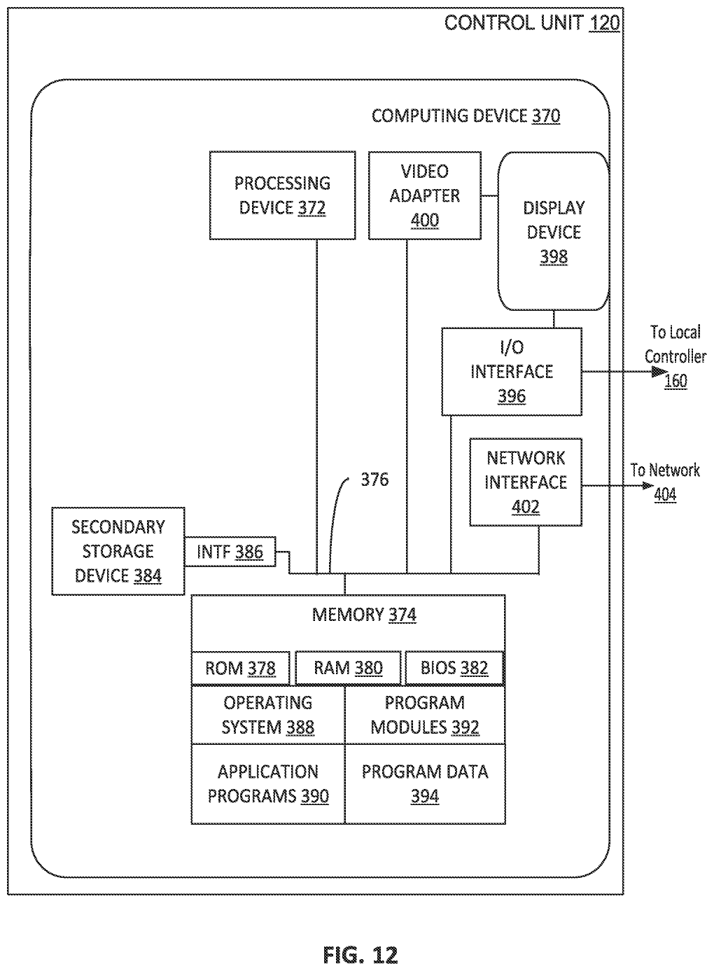

The transmission line installation system 100 further includes a control unit 120 configured to operate various components along the transmission line installation system 100. An example control unit 120 is illustrated and described in further detail with reference to FIG. 12. The transmission line installation system 100 may include any number of advancement devices 112 placed along the length of the conduit C. The transmission line installation system 100 may end at an end access point 130. The control unit 120 is illustrated and described in further detail with respect to FIG. 10.

Furthermore, the advancement device 112 may include an actuator 166 and a transmission line sensor 560. The actuator 166 is configured to frictionally engage the advancement device drive assembly 150 with the transmission line 110 to provide an advancement force to the transmission line 110 and advance the transmission line 110 downstream within the transmission line installation system 100. In some embodiments, the actuator 166 is a clamp cylinder. In some embodiments, the advancement device 112 includes upper and lower tractor drives 154, 156 that are configured to frictionally engage the transmission line 110. The transmission line sensor 560 is positioned downstream of the actuator 166 within the advancement device 112 to sense the presence of the transmission line 110 within the advancement device 112. When the transmission line sensor 560 senses the transmission line 110, it sends feedback to the actuator 166 via a local controller 160 to actuate by frictionally engaging the transmission line 110. In some embodiments, local controllers 160 positioned within each advancement device 112 may communicate via a control unit 120. The control unit 120 is configured to receive information from each local controller 160, process the information using a processor, and provide instruction to each local controller 160. In some embodiments, each local controller 160 may calculate a speed of the transmission line 110 at their respective advancement device 112 and transmit that speed to the control unit 120. The global controller may then process this information and transmit a synchronized speed to the local controllers 160 to adjust the speed of the transmission line 110 at each advancement device 112 to the synchronized speed. It is desirable to advance the transmission line 110 at a synchronized speed to prevent stretching the transmission line 110 or creating excess slack of the transmission line 110 within the transmission line installation system 100.

Furthermore, the advancement device 112 may include an incoming conduit segment 240 and an outgoing conduit segment 242. The incoming conduit segment 240 is configured to receive a transmission line 110 from a conduit C at an access point first end 126 and guide the transmission line 110 to the advancement device 112. The outgoing conduit segment 242 is configured to receive a transmission line from the advancement device 112 and guide the transmission line 110 to a conduit C at an access point second end 128. In embodiments, the access point first end 126 and the access point second end 128 may be located on the same side of an access point 118.

The transmission line installation system 100 is usable by one or more installation technicians to install a transmission line 110 into the site. In some embodiments, the transmission line installation system 100 is automated such that a transmission line 110 may be installed throughout a conduit C without requiring the use of one or more installation technicians.

In a typical scenario, one or more conduits C are buried underground at a site along a desired route prior to cable installation. The conduit C includes access points 118, which are openings in the conduit C through which the interior of the conduit C can be accessed. In some embodiments the access points 118 are placed at predetermined locations based on a maximum estimated advancement distance that the advancement device 112 can advance the transmission line 110. As the maximum advancement distance of the advancement device 112 is increased, fewer access points 118 are required, which significantly reduces the costs of installing a transmission line 110. As depicted in the example illustrated in FIG. 1, the conduit C may extend from the advancement device 112 to a distal end 350. The transmission line installation system 100 may end at an end access point 130.

Examples of a transmission line installation system 100 that can advance a transmission line 110 through at least one advancement device 112 are described in further detail in U.S. Non-Provisional application Ser. No. 17/761,962 and U.S. Provisional Applicational 63/355,571, the disclosures of which are hereby incorporated by reference in their entireties.

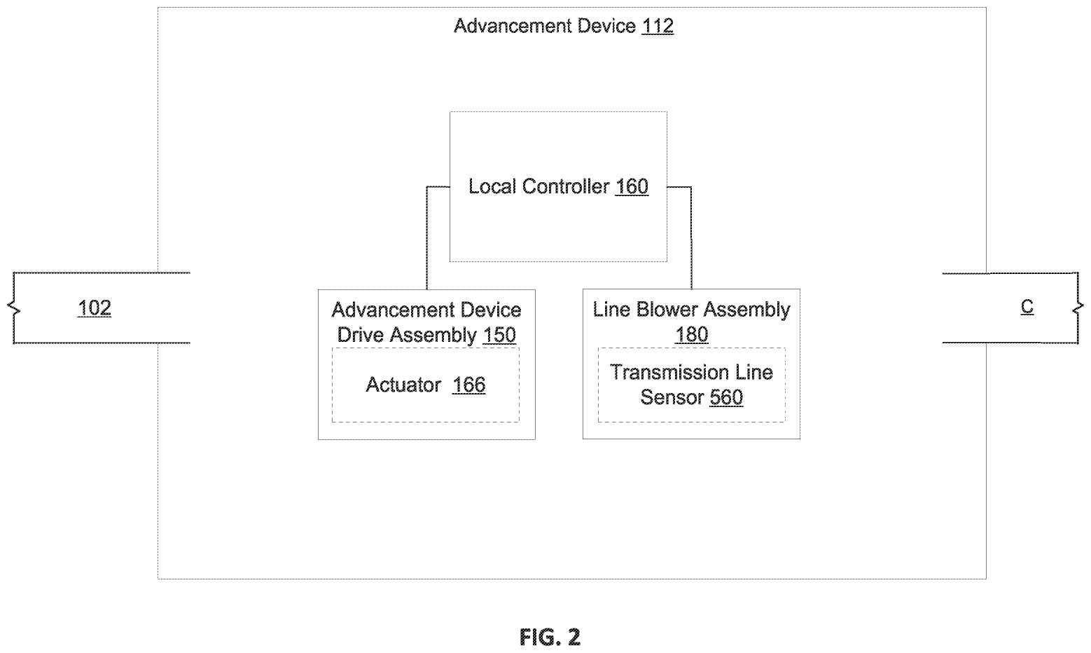

FIG. 2 is a block diagram of the example advancement device 112 within the transmission line installation system 100 of FIG. 1.

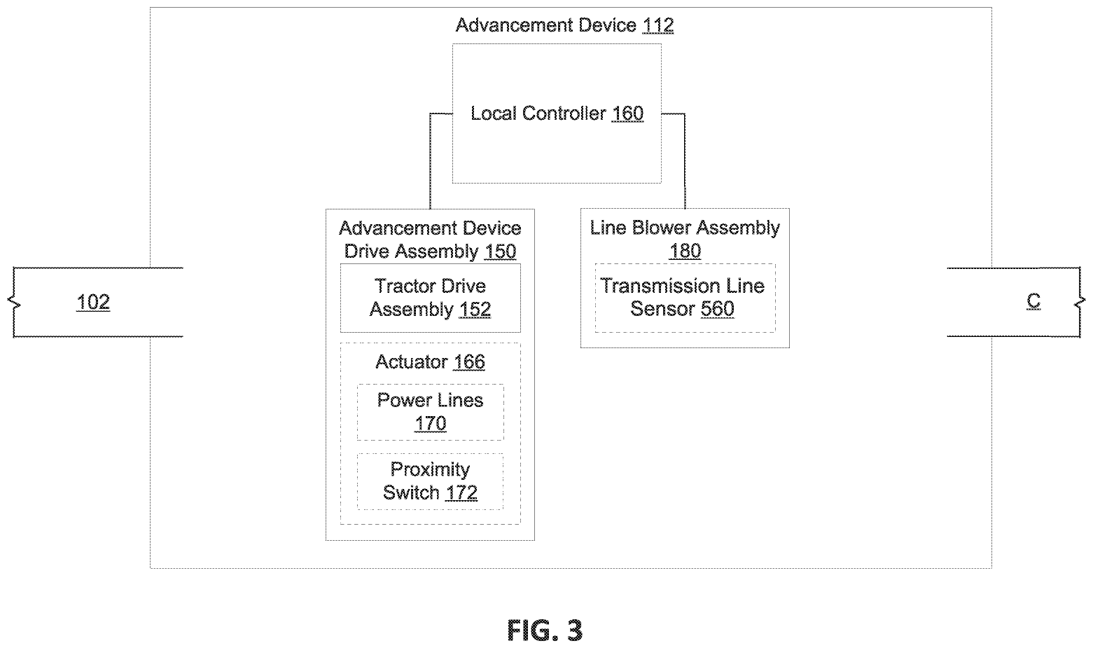

The example advancement device 112 includes an advancement device drive assembly 150 and a line blower assembly 180 operably controlled by a local controller 160. The advancement device drive assembly 150 is configured to receive a transmission line 110 from a transmission line source 102. The line blower assembly 180 is configured to receive the transmission line 110 from the advancement device drive assembly 150 and advance the transmission line 110 to a conduit C. In some embodiments, the advancement device drive assembly 150 includes an actuator 166 configured to engage the advancement device drive assembly 150 with the transmission line 110 to advance the transmission line 110. In some embodiments the line blower assembly 180 includes a transmission line sensor 560 configured to sense the presence of the transmission line 110 within the advancement device 112 and communicate the presence of the transmission line 110 to the advancement device drive assembly 150 via a local controller 160. In some embodiments, the transmission line sensor 560 includes a light emitter configured to emit light and detect a drop in voltage at a light sensor when the light is blocked by the transmission line 110. In some embodiments, the light emitter is configured to emit infrared light or visible light. In some embodiments, the transmission line sensor 560 may include a mechanical sensor. In some embodiments, the transmission line sensor 560 may include an electrical sensor. The actuator 166 and transmission line sensor 560 are illustrated and described in further detail with respect to FIGS. 3-9.

FIG. 3 is a block diagram of the example advancement device 112 of FIGS. 1-2, including an advancement device drive assembly 150 having a tractor drive assembly 152 and an actuator 166 including power lines 170 and a proximity switch 172.

In some embodiments, the advancement device drive assembly 150 includes a tractor drive assembly 152 having a pair of opposing tractor drives 154, 156, including an upper tractor drive 154 and a lower tractor drive 156. The actuator 166 is configured to frictionally engage the tractor drives 154, 156 with the transmission line 110 to advance the transmission line 110. In some embodiments, the actuator 166 operates to move a portion of the tractor drive assembly 152 using hydraulic, electric, or pneumatic power that is supplied through the power lines 170, or from the drive assembly power source 164. In some embodiments, the power lines 170 are hydraulic, electric, or pneumatic power lines.

In some embodiments, the advancement device 112 includes a proximity switch 172 configured to sense a position of the upper tractor drive 154 and the lower tractor drive 156. In some embodiments, the proximity switch may be a sensor. The proximity switch 172 may transmit the position of the tractor drives 154, 156 to the local controller 160. The local controller is configured to receive a signal from the proximity switch 172, process the transmission, and transmit an instruction to the actuator 166 to adjust the positioning of the upper and/or lower tractor drives 154, 156 to provide an appropriate pressure to the transmission line 110 as the tractor drives 154, 156 frictionally engage the transmission line 110. It is desirable to engage the transmission line 110 at an appropriate pressure to prevent damage to the transmission line 110 if too much pressure is applied or to prevent slippage. Slippage occurs when the transmission line 110 travels at a speed that is greater than or less than the upper and lower tractor drives 154, 156. The process of engaging the transmission line 110 at a proper pressure using the tractor drives 154, 156 is illustrated and described in further detail with respect to FIG. 5. The proximity switch 172 is configured to automate the adjustment of the tractor drives 154, 156 using the actuator 166; however, in some embodiments, the positioning of the tractor drives 154, 156 may be adjusted manually using the actuator 166. In some embodiments where a manual adjustment is performed, the actuator 166 includes a lever configured to be actuated by a user.

FIG. 4 illustrates and describes an example advancement device 112. Specifically, FIG. 2 illustrates an initial advancement device 122. The initial advancement device 122 receives a transmission line 110 from a transmission line source 102. In certain embodiments, the transmission line source 102 may include a transmission line reel 108. In certain embodiments, the transmission line reel 108 may be positioned on top of a reel stand 106. The initial advancement device 122 receives the transmission line 110 from the transmission line source 102 and advances the transmission line 110 using an advancement device drive assembly 150 and a line blower assembly 180. The advancement device drive assembly 150 and line blower assembly 180 are illustrated and described in further detail with reference to FIGS. 1-3 and 5-9. The advancement device 112 further includes a local controller 160 configured to control various components within the advancement device 112. After receiving the transmission line 110 from a transmission line source 102 and applying an advancement force to the transmission line 110, the initial advancement device 122 is configured to advance a transmission line 110 to a conduit C.

FIG. 5 is a cross-sectional view of the example initial advancement device 122 within the transmission line installation system 100 of FIG. 1. The initial advancement device 122 is an example advancement device 112 having a transmission line source 102 such as a transmission line reel 108. The transmission line 110 is provided to the initial advancement device 122 by the transmission line source 102, which may include a reel stand 106 supporting a transmission line reel 108 for supplying transmission line 110 to the advancement device 112. The initial advancement device 122 includes an advancement device drive assembly 150 and a line blower assembly 180.

In some embodiments, the advancement device 112 includes one or more of an inlet 184 and outlet 186 for receiving the transmission line 110 or for advancing the transmission line 110 beyond the advancement device 112, a line blower assembly 180, an air block 802, a seal 188, a duct mount assembly 210 (also sometimes referred to as a duct clamp or a conduit receptacle), a transmission line counter assembly 192, an adjustment assembly 194, a frame 196, and a lead-out guide 212.

The advancement device drive assembly 150 includes a tractor drive assembly 152 having an upper tractor drive 154 and a lower tractor drive 156. The upper tractor drive 154 and the lower tractor drive 156 are driven by an upper drive motor 158 and a lower drive motor 162, respectively. The upper drive motor 158 and the lower drive motor 162 are powered by a drive assembly power source 164. In some embodiments, the drive assembly power source 164 is a hydraulic, pneumatic, or electric motor.

Each tractor drive 154, 156 includes a moveable member (not shown). In some embodiments, an endless chain in each tractor drive 154, 156 is driven by the upper drive motor 158 and the lower drive motor 162 so as to frictionally engage the transmission line 110 and apply an advancement force to the transmission line 110. In the illustrated embodiment, the upper and lower tractor drives 154, 156 oppose each other and are aligned in an advancement direction D. Other moveable drive members besides opposed endless chains are possible including wheels and/or belts. Further, the moveable members can be arranged in V-shape, for example.

The advancement device drive assembly 150 may include a drive counter 168 for monitoring movement of the lower tractor drive 156, which is indicative of the speed of the advancement device drive assembly 150, and correspondingly indicative of the speed of the transmission line 110 as it enters the conduit C. Such speed monitoring is important for preventing excessive relative speed between the advancement device drive assembly 150 and the transmission line 110 during slippage, which occurs when the transmission line 110 travels at a speed that is greater than or less than the upper and lower tractor drives 154, 156. Furthermore, speed monitoring is important for synchronizing an advancement speed of the transmission line 110 at each advancement device 112 within the transmission line installation system 100.

Furthermore, the speed of the transmission line may be monitored using the transmission line sensor 560 that is configured to sense optical markings 114 placed along the transmission line 110. The transmission line sensor 560 may include an optical sensor (not shown) that is configured to sense the optical markings 114 as the transmission line 110 passes through the advancement device 112. The transmission line sensor 560 counts the optical markings 114 that pass the transmission line sensor 560 over a period of time. By measuring the number of optical markings 114 that pass the transmission line sensor 560, wherein the optical markings 114 are evenly spaced at a predetermined distance, the transmission line sensor 560 may measure the total distance of transmission line 110 that passes the transmission line sensor 560 over a period of time. The transmission line sensor 560 may then transmit this information to the local controller 160 for the local controller 160 to process and calculate a speed of the transmission line 110.

Speed monitoring is also important so that it can be communicated to other components 340, such as to synchronize their operations within a single advancement device 112 (such as to keep several advancement devices 112 all operating at the same speed) or to synchronize their operations with multiple advancement devices 112. When the speed is calculated by the drive counter 168, the speed is communicated from the drive counter 168 to the local controller 160 which receives the speed measurement. The speed can then be communicated from the local controller 160 to other components 340 or the control unit 120. The control unit 120 can then communicate that speed to other advancement devices 112 within the transmission line installation system 100. Alternatively, the speed monitoring can be used to adjust the speed of the advancement device 112 so that it matches an instructed speed. For example, if the local controller 160 receives an instruction from a control unit 120, or a global controller to adjust to a certain speed of operation, the speed measurement can be used to determine whether the speed needs to be increased or decreased to match the instructed speed, and to confirm once the instructed speed has been achieved. In embodiments, a control unit 120 may be a global controller. This enables a plurality of advancement devices 112 to communicate with one another to synchronize and operate at a synchronized speed. Operating at a synchronized speed is desirable because it prevents segments of a transmission line 110 from traveling at non-uniform speeds, which may result in coiling and damaging the transmission line 110. The control unit 120 is illustrated and described in further detail with reference to FIGS. 10 and 12. The local controller 160 is illustrated and described in further detail with reference to FIGS. 10-12.

The initial advancement device 122 provides an advancement force for the installation of the transmission line 110 to be pulled from the transmission line reel 108, or other transmission line source 102, and inserted into an interior of conduit C. The conduit C can be any of a variety of known ducts, such as polyethylene, suitable for receiving and storing the transmission line 110. Once installed in the duct, the transmission line 110 can subsequently be used, such as for transmission of light or electrical signals, or power. As discussed, herein, the transmission line 110 can be any of a variety of known cables or wires used for transmitting energy or signals, including fiber optic cable having one or more optical fibers contained therein, and preferably having a circular outer perimeter. The advancement device 112 receives the transmission line 110 at an inlet 184, and the transmission line 110 exits the advancement device 112 at an outlet 186. The conduit C extends from the advancement device 112 to the distal end 206, which can be several hundred feet or less away from the advancement device 112, or several thousand feet or more away from the advancement device 112. The inlet 184 and outlet 186 may include a lead-in guide 214 for guiding the transmission line 110 into the advancement device 112.

In some embodiments the advancement device drive assembly 150 further includes a hold down system, such as the actuator 166, linked to the drive assembly power source 164. The actuator 166 generates a predetermined normal force on the transmission line 110 between the upper and lower tractor drives 154, 156. Some slip is acceptable. Too much slip can cause transmission line 110 damage, such as damage to the transmission line jacket. Too much slip may also limit the usefulness of the advancement device 112 if insignificant push forces are generated. A conduit or duct usually contains some irregularities, joints and bends that can keep transmission line 110 from moving smoothly. Unless an appropriate normal force is generated (not too much slip), the pushing force may be inadequate to overcome the irregularities, and slip may occur too often, causing unnecessary transmission line 110 damage or insignificant transmission line push force. On the other hand, a normal force which is too high risks crush damage to the transmission line 110, and inadequate slippage, such that column damage will be more likely to occur as the advancement device drive assembly 150 continues to move the transmission line 110 when transmission line 110 is being slowed or stopped within the conduit or duct. When slip does occur under high normal force loads, transmission line 110 damage may result. By providing for a predetermined normal force with the advancement device 112, predetermined slip levels can be monitored. This results in an appropriate level of slip, so as to not cause too many shutdowns of the advancement device 112 when transmission line 110 damage is not significantly at risk, but excessive slip is noted, and can be used to shut off the advancement device 112 to prevent damaging the transmission line 110.

Some embodiments of the advancement device 112 further include a line blower assembly 180 for advancing a transmission line 110 through the advancement device 112 using pressurized fluid. In some embodiments, the pressurized fluid includes a gas or a liquid. In some embodiments, the advancement device 112 includes one or more of an inlet 184 for receiving the transmission line 110 from a transmission line source 102 and an outlet 186 for advancing the transmission line 110 beyond the advancement device 112.

The line blower assembly 180 is linked to a compressor 198, which generates appropriate fluid pressure. The air hose 200 and a valve 208 link the compressor 198 with the line blower assembly 180. The valve 208 can be manually or electronically adjustable. An electronically adjustable valve is electronically connected to the local controller 160, which can adjust the valve 208 between open and closed positions, or to various partially opened positions, to adjust the air flow through the line blower assembly 180 and into the conduit C. Air pressure within the conduit C between a carrier (not shown) and the advancement device 112 causes a carrier to move toward the distal end 206 of the conduit C where it exits the conduit C.

The carrier is attached to a distal end 352 (also referred to as the leading edge) of the transmission line. The carrier slidably and sealably closes off conduit C from the atmosphere to create a pressure difference adjacent to the carrier. The pressurized air within the conduit C, behind the carrier, flows along sides of the transmission line 110 which can generate an advancement pulling force at the distal end 352 of the transmission line. The flow of air can also generate a pillow of air that helps to space the transmission line 110 from the interior surface of the conduit C to reduce frictional contact between the transmission line 110 and the conduit C. Further, if the carrier does not completely seal the duct, the air will flow along the conduit at a faster speed than the transmission line 110. This creates a distributed viscous drag between the air flow and the transmission line 110 that further helps to propel the transmission line 110 along the conduit C by pulling on the transmission line 110 along the entire length of the transmission line 110. A further advantage of this is that it reduces the required pushing and pulling forces that are localized to the distal end 352 and proximal end 354 of the transmission line 110, which if too great can result in damage to the transmission line 110.

In some embodiments the advancement device 112 further includes the transmission line counter assembly 192, which monitors the speed of the transmission line 110 during operation. Preferably, the transmission line counter assembly 192 also monitors the length of the transmission line 110 passing through the advancement device drive assembly 150 from the transmission line reel 108. Similar to the line counter assembly 192 discussed herein for the reel stand 106, the line blower assembly 180 can similarly include an optical counter (not shown) that reads markings 114 on the exterior of the transmission line 110 as it passes through the advancement device drive assembly 150. The length is communicated to and received at the local controller 160, for communication to other components 340 or the control unit 120.

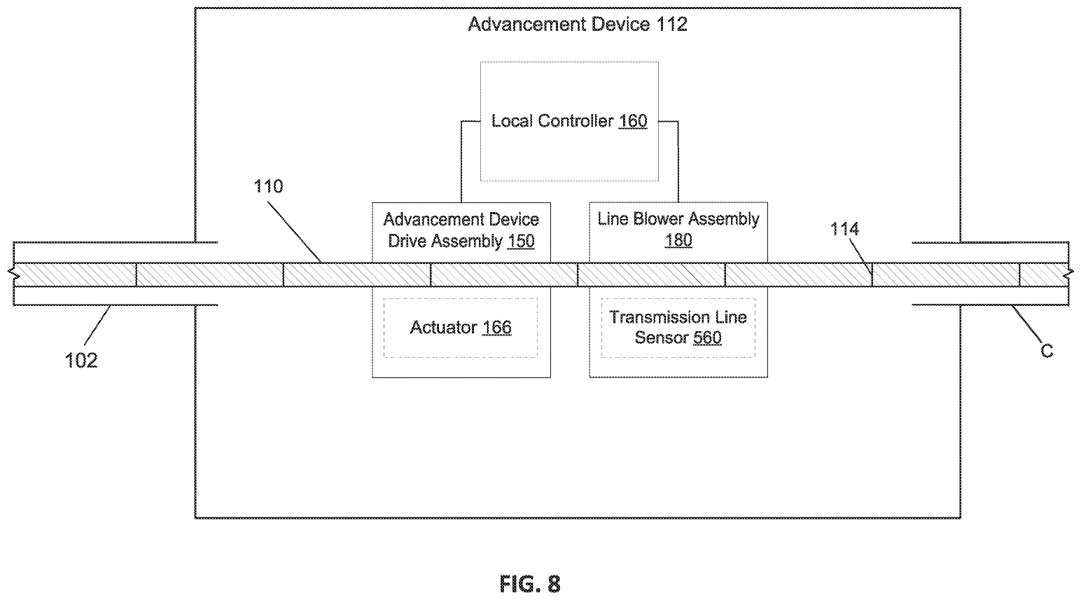

In some embodiments the transmission line counter assembly 192 is used to detect slip of the transmission line 110 within the advancement device drive assembly 150. Slip typically occurs between the transmission line 110 and the advancement device drive assembly 150, such as the upper and lower tractor drives 154, 156. One way to detect slip is to compare the measurements read by the transmission line counter assembly 192 with other speed or distance measurements in the system, such as the line blower assembly 180 distance measurement, or the distance from the transmission line reel 108. When the speeds or distances do not match (or deviate by more than a particular amount), the system can determine that the transmission line 110 is slipping in the advancement device drive assembly 150. Remedial action can then be taken, such as to reduce the air pressure, alert the operator, or other remedial action. In some embodiments, the transmission line counter assembly 192 is used to detect differences in the speed of the transmission line 110 at each advancement device 112. Differences in the speed of the transmission line 110 are caused by different advancement forces being applied to the transmission line 110 by various advancement devices 112 within the transmission line installation system 100. Remedial action can be taken to measure the speed of the transmission line 110 at a first location relative to the speed of the transmission line 110 at a second location and adjust the advancement speed of the transmission line 110 at a location to synchronize the advancement speed of the transmission line 110 throughout the transmission line installation system 100. Another way to compare measurements is to read optical markings 114 along the transmission line 110 using the transmission line sensor 560 as described above and illustrated in further detail with respect to FIG. 8.

FIG. 6 is a block diagram of an advancement device 112 of FIG. 1, and specifically a subsequent advancement device 124, having a local controller 160, an advancement device drive assembly 150, and a line blower assembly 180 for advancing a transmission line 110 through a conduit C. The subsequent advancement device 124 receives a transmission line 110 from the conduit C at a point in the transmission line installation system 100 that is downstream an initial advancement device 122 and a transmission line source 102. The subsequent advancement device 124 advances the transmission line 110 using an advancement device drive assembly 150 and a line blower assembly 180. The advancement device drive assembly may include an actuator 166 in an embodiment of the invention. In one embodiment, the line blower assembly 180 may include a transmission line sensor 560. The advancement device drive assembly 150 and line blower assembly 180 are illustrated and described in further detail with reference to FIGS. 1-5 and 7-9. The advancement device 112 further includes a local controller 160 configured to control various components within the advancement device 112. After receiving the transmission line 110 from a transmission line source 102 and applying an advancement force to the transmission line 110, the initial advancement device 122 is configured to advance a transmission line 110 to a conduit C.

FIG. 7 is a cross-sectional view of the example subsequent advancement device 124 of FIG. 6 further illustrating various components within the advancement device 112. The subsequent advancement device 124 includes many of the same components as the initial advancement device 122, including the advancement device drive assembly 150 and the line blower assembly 180. Additionally, the subsequent advancement device 124 receives the transmission line 110 and pressurized fluid from a conduit C at an inlet 184 through a lead-in guide 214. In embodiments, the lead-in guide 214 and the lead-out guide 212 are funnel shaped in a manner that will direct the transmission line 110 in a particular direction. In some embodiments the lead-in guide 214 and the lead-out guide system 212 have a tapered configuration including a wide end for receiving the transmission line 110 and a narrow end for guiding the transmission line 110. In embodiments, there may be more than one lead-in guide 214 and the lead-out guide 212 in the advancement device 112 or components 340. Other components in this Figure are illustrated and described in further detail with respect to FIG. 5.

FIG. 8 is a block diagram of the example advancement device 112 of FIG. 2, including a transmission line 110 having optical markings 114.

The advancement device 112 is configured to receive the transmission line 110 from a transmission line source 102 and advance the transmission line 110 through the advancement device drive assembly 150 and the line blower assembly 180 to a conduit C as illustrated and described in FIGS. 2 and 8. Additionally, FIG. 8 illustrates the transmission line sensor 560 reading optical markings 114 as the transmission line 110 is advanced through the advancement device 112 as illustrated and described in FIGS. 3-6. In some embodiments, the optical markings 114 include circumferential lines about the transmission line 110. In some embodiments, the optical markings 114 are evenly spaced from one another along the length of the transmission line 110. In some embodiments, the optical markings 114 are spaced a predetermined distance apart from one another along the length of the transmission line 110 such that the local controller 160 can calculate the speed of the transmission line 110 from information recorded by the transmission line sensor 560 as illustrated and described in further detail with respect to FIGS. 3-6.

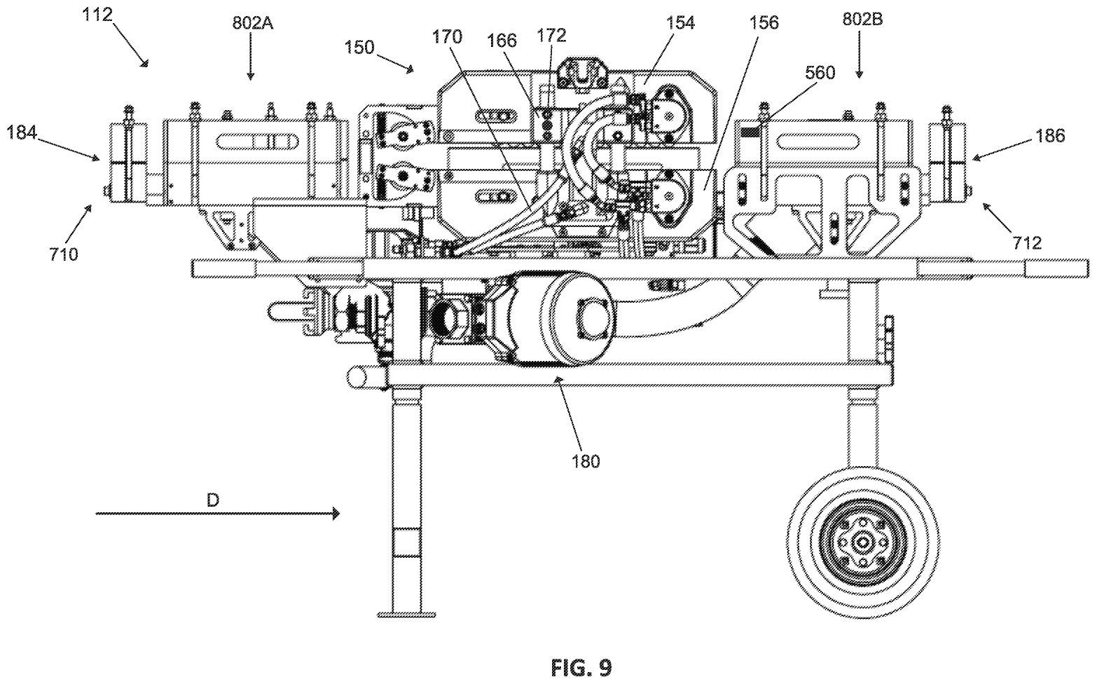

FIG. 9 is a side view of an advancement device 112 illustrating the components of FIGS. 1-8. In the depicted example, the transmission line 110 is received at the inlet 184 and advanced through an air block 802A and the transmission line counter assembly 192 (as shown in FIG. 7) to the advancement device drive assembly 150. The transmission line 110 then passes the actuator 166 before reaching the transmission line sensor 560. The transmission line sensor 560 is positioned at any point downstream of the actuator 166 along a direction of travel D within the transmission line installation system 100. The transmission line 110 is then guided out of the advancement device 112 through a second air block 802B and the outlet 186. When the transmission line sensor 560 senses the transmission line 110, it may communicate the presence of the transmission line 110 to a local controller 160, where the local controller 160 then processes the communication and instructs the drive assembly power source 164 to supply power to the actuator 166 through power lines 170. The actuator 166 then adjusts the position of the upper and lower tractor drives 154, 156 to frictionally engage the transmission line 110. In some embodiments, the positioning of the upper and lower tractor drives 154, 156 via the actuator 166 is automated using a proximity switch 172, where the proximity switch 172 is configured to detect the position of the upper and lower tractor drives 154, 156 and transmit the position to the local controller 160, which then processes the transmission and instructs the actuator 166 to cease further adjustment of the upper and lower tractor drives 154, 156. In embodiments, the transmission line 110 may advance from the first end of the advancement device 710 to the second send of the advancement device 712.

FIG. 10 is a schematic block diagram illustrating a control unit 120 configured to communicate with at least one local controller 160 to implement various control systems. Similar to the example shown in FIG. 1, the example transmission line installation system 100 includes the transmission line conveying system 104, which also includes advancement devices 112. Some embodiments further include one or more of a route evaluation system 328, a remote control and diagnostics system 332, and an installation monitoring and management system 334. The example transmission line conveying system 104 includes the control unit 120 and a plurality of components 340, such as advancement devices 112 and hydraulic or electric power sources. In some embodiments the control unit 120 includes and operates as a controller 338 and the components include local controllers 160.

A fluid injection machine (not shown) is another example of a component 340. An example of a fluid injection machine is a lubricating machine, which is operable to add (apply or inject) lubricant onto the transmission line 110 or into the conduit C or duct. The lubricating machine can be arranged at the start of the run to apply lubricant to the transmission line 110 before it enters the conduit C or duct, or to inject lubricant into the starting end of the conduit C or duct. The lubricating machine includes a pump or other lubrication applicator, and includes a local controller 160 operable to interact with the control unit 120 and/or other components 340, and to control the operation of the lubricating machine, such as to adjust the amount of lubricant being added to the transmission line 110 or conduit C, or to turn on or off the addition of lubricant. In some embodiments the lubricating machine has various types of lubricant and can select between those types depending on the conditions, and even adjust the lubricant on the fly as installation proceeds. In another possible embodiment, the fluid injection machine can be integrated into an advancement device 112. In some embodiments, the fluid injection machine can be integrated with and combined with a moisturizer unit and/or an injection fluid tank.

A transmission line cleaner (not shown) is another example of a component 340, which is operable to clean a transmission line 110 before it enters the transmission line conveying system 104. The transmission line cleaner typically includes one or more cleaning mechanisms (motorized or non-motorized) such as sensors to detect foreign objects such as sand, mud, water, and the like, and determine whether and an extent of cleaning that is required, and then activates the cleaning mechanism to perform the appropriate cleaning. Cleaning mechanisms can include brushes, wipers, and water or other liquid baths. As with other components 340, the transmission line cleaner includes a local controller 160 to permit communication with other components 340, the control unit 120, and operates to control the operations of the cleaning mechanism itself. In some embodiments the transmission line cleaner is positioned before an optical detector (not shown but discussed herein) that reads optical markings 114 on the exterior of the transmission line 110. In some embodiments, the optical detector is the transmission line sensor 560. The cleaning removes any obstructions on the optical markings 114 that might otherwise interfere with the reading by an optical detector.

Some embodiments include a tether mechanism (not shown). A tether mechanism operates similarly to a line puller, but instead of pulling the transmission line toward it, it operates instead to provide a back pressure to provide more precise speed control to the transmission line 110, such as when using an advancement device 112 to advance the transmission line 110 through the conduit C or duct. The tether mechanism typically includes an elongate member (e.g., a tape or cable) that is connected to the transmission line (directly or with a coupler). In some embodiments the elongate member is connected to the line carrier. A line puller is an example of a tether mechanism when it is operated in reverse. In another embodiment, the tether mechanism can include a brake or other controllable slip interface that is operable to apply a braking force to control a speed at which the transmission line is advanced through the conduit C.

The control unit 120 operates as the primary user interface with the installation technician. The control unit 120 prompts the user, such as the installation technician or other user, to provide inputs to control the overall operation of the transmission line conveying system 104, such as start or stop inputs, and to define an installation plan including settings for the system. In some embodiments, the control unit 120 includes both a local communication device as well as a network communication device such as a cellular modem or Wi-Fi communication device. The local communication device can be either a wired or wireless communication system, such as a wired serial communication device (such as a universal serial bus (“USB”) device), or a wireless device (such as utilizing Wi-Fi or BLUETOOTH communication), which allows the control unit to communicate with the components 340 and their local controllers 160. The network communication device enables the control unit 120 of the transmission line conveying system 104 to communicate across the Internet or other network, such as with one or more of the route evaluation system 328, the remote control and diagnostics system 332, and the installation monitoring and management system 334.

The local controllers 160 can communicate with the control unit 120 and/or other local controllers 160. The local controllers 160 are coupled to other sensors or controllable devices within the components 340, and therefore are capable of receiving or generating data associated with the components 340 and are also able to control any controllable devices such as motors, pumps, and the like.

The communications can be used to transmit control commands or data. Control commands are issued by one controller 338 to another controller 338 and instruct the other controller to adjust an operation, such as to speed up or slow down, start or stop, increase or decrease a pull or push force, or other controllable operations.

Data communication is used to transmit information within the system. An example of a data transmission may include a temperature, speed, pressure, humidity, tension or force, or other information. Data may be generated by a sensor or may simply identify a current status or operational parameter of one of the components (e.g., indicating that the device is turned on, or indicating that the device is currently set to operate at a particular speed, etc.). Data received from one controller 338 by another controller 338 can be used by that other controller to react accordingly, such as to adjust its own operation, or may be used by the control unit 120 to send one or more commands to the components 340.

In some embodiments the control unit 120 and plurality of components 340 are configured to communicate with each other according to a predefined communication protocol to automatically identify each other and to make use of resources provided by the connected components. For example, when a first component 340 is added to the transmission line installation system 100, the first component 340 and the controller 338 communicate with each other to identify each other and determine the resources (including features and functionality) that are now available to the transmission line installation system 100 as a result. When additional components 340 are added the components 340 are similarly identified. The transmission line installation system 100 can therefore operate in such a way that it utilizes the resources available to it, and similarly can identify any problems or deficiencies in the current system configuration and make recommendations to the operator to change the configuration if needed. When an installation plan is developed, as discussed herein, the plan can be customized based on the specific configuration of the system at that time. Similarly, other parts such as the conduit C itself, the transmission line 110 or transmission line source 102, and the like can also be identified by the transmission line installation system 100, such as by reading an RFID tag or communicating with a local controller 160 associated with those parts, to identify characteristics of the parts.

In some embodiments the control unit 120 and the components 340 are fully operable individually regardless of whether or not they are connected with the control unit 120 or other components 340. When connected they cooperate with each other to utilize the resources of the others, and when disconnected they operate with whatever resources are available.

In various implementations the transmission line installation system 100 can operate in various different control and communication modes. Several examples include: (1) a master/slave control model in which the control unit 120 operates as a controller 338, where the control unit 120 is the master device and the local controllers 160 operate as slave devices; (2) a controller 338 and local controller 160 model utilizing peer-to-peer communication in which the controller 338 performs an advisory role and the local controllers 160 are capable of operating independently under the advice of the controller 338; and (3) a peer-to-peer model where the local controllers 160 cooperate but independently control their own components 340, and where the control unit 120 does not attempt to control the individual operations of the components 340, but rather performs the role of a primary interface with the installation technician, to provide the local controllers 160 with instructions received from the installation technician. Other communication and control modes are also possible. As one further example, the controller 338 can be part of one of the components 340, such as the advancement device 112. In yet another example, the role of a local controller 160 as the controller 338 can be passed from one component 340 to other components 340 during the course of an installation. For example, in some embodiments an advancement device 112A local controller 160 is the global controller while the distal end 352 (also referred to as the leading edge) of the transmission line is within the conduit C segment C1 that it controls, and then the global controller status switches to the local controller 160 of the advancement device 112B once the transmission line moves into the next conduit C segment C2. This can be beneficial because the advancement device 112 associated with the current conduit C segment may have the most current information about the status of the distal end 352 of the transmission line, and the other components 340 can provide support to that advancement device 112 in accordance with its instructions.

In some embodiments the controller 338 includes one or more of a processing device 360, a memory device 362, a communication device 364, a power supply, a display device, and an input device. The communication device can be a wired communication device or a wireless communication device. Data communication can occur through any one of a variety of standard wired or wireless data communication protocols. Examples of wired communication devices include modems, USB devices, serial and other I/O communication devices. Examples of wireless communication devices include cellular communication devices, Wi-Fi (IEEE 802.11x) communication devices, BLUETOOTH communication devices, and long range (LoRa) communication devices. The display device generates a user interface for the installation technician, such as a graphical user interface. The input device receives inputs from the installation technician. A touchscreen display can be utilized which includes both the display device and the input device.

The installation monitoring and management system 334 permits a supervisor or other person at a remote location to monitor and manage the transmission line installation system 100, and in some embodiments multiple other transmission line installation systems 100 at other sites. In some embodiments the installation monitoring and management system 334 monitors a status of the transmission line installation system 100, such as the configuration of the system 100 during setup, and the operation of the system 100 during a transmission line 110 installation. In some embodiments the installation monitoring and management system 334 performs fleet management functions, to assign technicians to installation teams, dispatch the teams to project sites, and monitor the progress of the installations. The management system 334 can also manage schedules, such as to display schedules for the coming days or weeks, and provide historical analysis, reporting, and heuristic data.

An example of a route evaluation system 328 that can perform the route evaluation and segment characterization is described in further detail in PCT Publication WO 2018/090043 (the '043 application), filed on Nov. 14, 2017, and in PCT Publication WO 2016/176467, filed on Apr. 28, 2016, the disclosures of which are hereby incorporated by reference in their entireties. As one example, a duct mapping device (such as the route evaluation device shown in FIG. 27 of the '043 application) is passed through the duct, and includes sensors (such as one or more of an accelerometer, gyroscope, global positioning system receiver, and the like (and may have multiple of these, such as one or more three-axis accelerometers), which map the movement and/or position of the duct mapping device as it moves through the conduit C. A detailed three-dimensional map of the conduit C route can then be generated, such as including a series of X, Y, and Z coordinates defining the position of the conduit C at frequent intervals along the route. The route evaluation system 328 can therefore generate a detailed route map defining the position and features of the conduit C route along the full length of the conduit.

In some embodiments the duct mapping device provides the route geometry including, for example, the degrees of bends, the radius of the bends, the cumulative amount of bends, whether a minimum bend radius of the cable is exceeded, and X, Y & Z GPS coordinates of the duct taken at certain intervals, such as at a sampling rate of 100 Hz intervals.

Other examples of duct mapping devices that can be utilized for route evaluation and segment characterization are the mapping tools available from Reduct NV, of Schelle, Belgium, including the ABM-30 gyro mapping tool, ABM-40 MEMS based mapping probe, the ABM-80 and ABM-90 wheeled mapping tools, the DR-2 fiber optic gyroscope mapping probe, DR-3 mapping tool, and DR-4 multi-purpose pipeline mapping system.

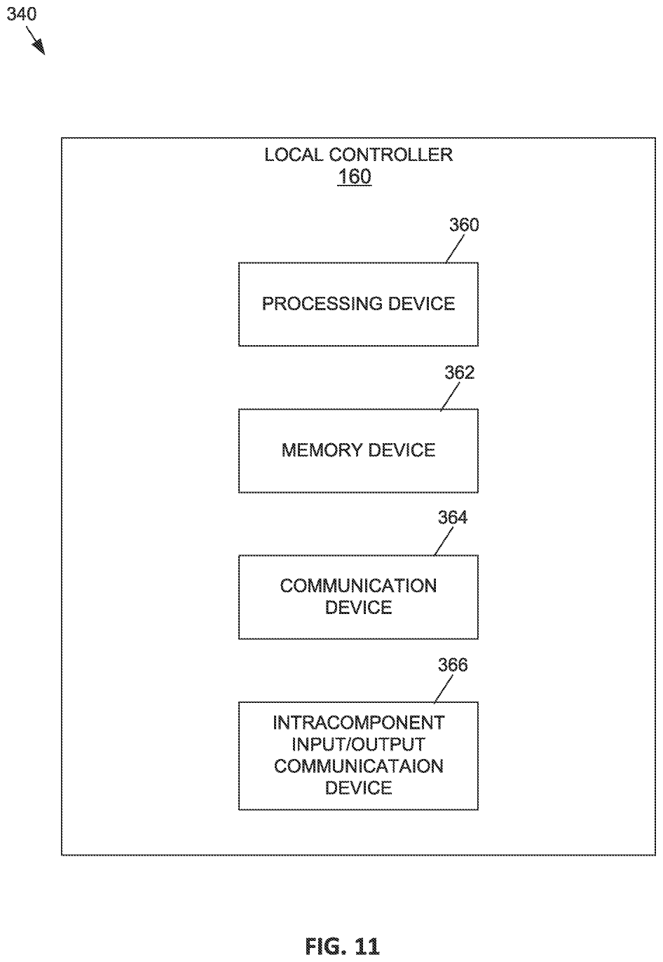

FIG. 11 is a schematic block diagram illustrating another example of the local controller 160 of a component 340 of the transmission line installation system 100.

The same or similar local controller 160 can be used with any of the components 340 of the transmission line installation system 100. Examples of the components 340 that can include the local controller 160 include power sources, advancement devices 112 (or other transmission line conveying apparatus), an air heater, an air cooler, an air humidifier, an air dryer, a static charge elimination device, a moisturizer, and a lubricator. Other components of the transmission line installation system 100 may also include a local controller 160 if data communication, synchronization, or control of the component is desired. In some embodiments the control unit 120 can include a local controller 160, for example, in some embodiments the control unit 120 is integrated with another component 340, such as the advancement device 112.

The local controller 160 controls the overall operation of the component 340, and communicates through the communication device 364 with one or more other components 340 of the transmission line installation system 100. For example, in some embodiments the local controller 160 receives commands in the form of messages or instructions from the control unit 120 through the communication device 364. Examples of such commands include start, stop, and speed adjustments (a particular speed setting, an instruction to increase the speed, or an instruction to decrease the speed, etc.). Further, in some embodiments the local controller 160 also sends messages or instructions to other components through the communication device 364. For example, measured data or current or historical settings can be transmitted by the local controller 160 to other components.

The processing device 360 operates to process data instructions to perform functions of the component 340. The memory device 362 stores data instructions, which when executed by the processing device 360, cause the processing device 360 to perform those functions. The memory device 362 does not include transitory media carrying data signals. An example of the memory device 362 is a non-transitory computer readable storage device as described in further detail herein.

The communication device 364 is a device that communicates with other devices via wired or wireless data communication. In some embodiments the communication device 364 communicates with one or more of the control unit 120 and other components 340 of the transmission line installation system 100.

The communication device 364 can utilize wireless or wired communication devices. Examples of wireless communication devices include cellular communication devices, Wi-Fi (IEEE 802.1 1x) communication devices, and BLUETOOTH communication devices. Wired communication devices include modems, USB devices, serial and other I/O communication devices and techniques.

The intracomponent input/output communication device 366 operates to communicate with and control subsystems, sensors, or other electronic or controllable devices within the component 340, utilizing wired or wireless communication or control signals. For example, the intracomponent input/output communication device 366 is coupled to and controls mechanical, pneumatic, or electronic components such as motors, brakes, sensors (e.g., temperature, moisture, transmission line tension, speed, line counter, etc.).

Examples of processing devices 360, memory devices 362 (including computer readable storage devices), and communication devices 364 are described herein with reference to an example computing device 370, and also with reference to the local controllers 160, and such descriptions similarly apply to the processing device 360, memory device 362, and communication device 364 of the example local controller 160 shown in FIG. 12.

FIG. 12 is a schematic block diagram illustrating another example of the local controller 160 of a component of the transmission line installation system 100 illustrated and described in FIGS. 1-9. FIG. 12 is an example of a local controller 160 or a control unit 120.

FIG. 12 illustrates an exemplary architecture of a computing device 370 that can be used to implement aspects of the present disclosure, including any of the plurality of the computing devices described herein, including the control unit 120, controller 338, and any other computing device involved in the transmission line installation system 100.

Further, the computing device 370 can also be implemented as part of any one or more of the transmission line installation system 100 components discussed herein, such as a portion of the reel stand 106, the transmission line conveying system 104 (including the power source 116 (see FIG. 5), and/or the advancement device 112). The computing device 370 can be used to execute the operating system, application programs, and software modules (including the software engines) described herein. By way of example, the computing device 370 will be described below as an example of the control unit 120. To avoid undue repetition, this description of the computing device 370 will not be separately repeated herein for each of the other computing devices, including those listed above, but such devices can also be configured as illustrated and described with reference to FIG. 10.

In this example, the control unit 120 includes a computing device 370. The computing device 370 can be used to execute the operating system, application programs, methods, and software modules, and to perform any one or more of the functions of the control unit 120, described herein.

The computing device 370 includes, in some embodiments, at least one processing device 372, such as a central processing unit (CPU). A variety of processing devices 372 are available from a variety of manufacturers, for example, Intel or Advanced Micro Devices. In this example, the computing device 370 also includes a system memory 374, and a system bus 376 that couples various system components including the system memory 374 to the processing device 372. The system bus 376 is one of any number of types of bus structures including a memory bus, or memory controller; a peripheral bus; and a local bus using any of a variety of bus architectures. Examples of computing devices suitable for the computing device 370 include a server computer, a desktop computer, a laptop computer, a tablet computer, a mobile computing device (such as a smart phone, an iPod® or iPad® mobile digital device, or other mobile devices), or other devices configured to process digital instructions.

The system memory 374 includes read only memory (“ROM”) 378 and random-access memory (“RAM”) 380. A basic input/output system (“BIOS”) 382 containing the basic routines that act to transfer information within computing device 370, such as during start up, is typically stored in the read only memory 378. The computing device 370 also includes a secondary storage device 384 in some embodiments, such as a hard disk drive, for storing digital data. The secondary storage device 384 is connected to the system bus 376 by a secondary storage interface (“INTF”) 386. The secondary storage devices 384 and their associated computer readable media provide nonvolatile storage of computer readable instructions (including application programs and program modules), data structures, and other data for the computing device 370.

Although the exemplary environment described herein employs a hard disk drive as a secondary storage device, other types of computer readable storage media are used in other embodiments. Examples of these other types of computer readable storage media include magnetic cassettes, flash memory cards, digital video disks, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 384 or system memory 374, including an operating system 388, one or more application programs 390, other program modules 392 (such as the software engines described herein), and program data 394. The computing device 370 can utilize any suitable operating system, such as Microsoft Windows™, Google Chrome™, Google Android, Apple OS, Apple iOS, Linux, and any other operating system suitable for a computing device.

In some embodiments, a user provides inputs to the computing device 370 through one or more input devices, such as the display device 398. Other input devices can also be used, such as a keyboard, mouse, pointer control device (such as a touch pad, touch stick, joystick, etc.), microphone, and any other suitable input device. The input devices are often connected to the processing device 372 through an input/output (“I/O”) interface 396 that is coupled to the system bus 376. Wireless communication between input devices and the interface 396 is possible as well, and includes infrared, BLUETOOTH® wireless technology, IEEE 802.11x Wi-Fi technology, cellular, or other radio frequency communication systems. Therefore, in some embodiments the I/O interface 396 is a wireless communication device.

One or more input/output interfaces 396 can be used for communicating with other components 340 of the transmission line installation system 100, such as the transmission line source 102, and transmission line conveying system 104. The input/output interface 396 can include AC, DC, or digital input output interfaces, including for example USB and other I/O interfaces, and can also or alternatively include one or more communication devices such as a wireless communication device, wired network communication device (e.g., a modem or Ethernet communication device), or other wired communication devices (e.g., serial bus). The I/O interface 396 can communicate with the local controllers 160 of other components 340 of the transmission line installation system 100, for example. In some embodiments the communication includes communication of data and commands. Examples of data include sensor data, such as a temperature, humidity, transmission line length, transmission line speed, reel feed speed, and other data describing current operating conditions. Examples of commands include start, stop, setting adjustments, and the like.

In this example embodiment, a display device 398, such as a monitor, liquid crystal display device, projector, or touch sensitive display device, is also connected to the system bus 376 via an interface, such as a video adapter 400. In addition to the display device 398, the computing device 370 can include various other peripheral devices (not shown), such as a wireless headset, speakers, and a printer.

When used in a local area networking environment or a wide area networking environment (such as the Internet), the computing device 370 is typically connected to a network 404 through a network interface 402, such as an Ethernet interface, or by a wireless communication device, such as using cellular or Wi-Fi communication. In some embodiments the network interface 402 is a cellular modem that can access the Internet through a cellular network. The network interface 402 can communicate with remote systems, such as a route evaluation system.

The computing device 370 typically includes at least some form of computer readable media. Computer readable media includes any available media that can be accessed by the computing device 370. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 370. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

In some embodiments the computing device 370 includes or is connected to a location determining device, such as a global positioning system (GPS) receiver.

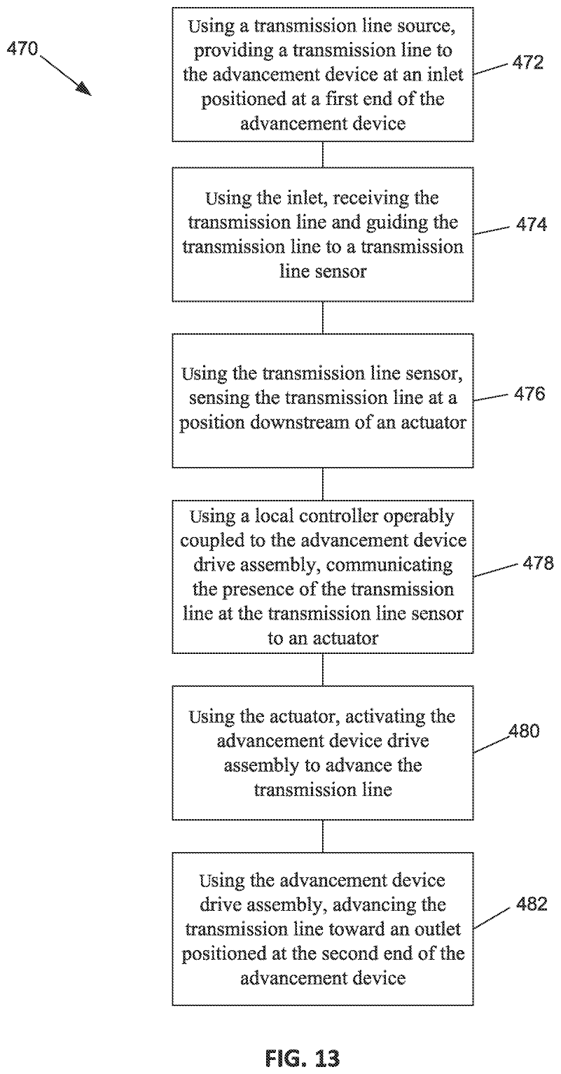

FIG. 13 is a flow chart illustrating a method 470 for advancing a transmission line 110 using an advancement device 112.

In a first operation 472, a transmission line 110 is supplied to the advancement device 112 at an inlet 184 at a first end 710 of the advancement device 112 using a transmission line source 102. This operation is illustrated and described in further detail with respect to FIG. 9.

In a second operation 474, the inlet 184 receives the transmission line 110 and pressurized fluid from an upstream pressurized fluid source and guides both the transmission line 110 and the pressurized fluid into the advancement device 112. In one embodiment, the upstream pressurized fluid source may be an initial advancement device 122 that is upstream of the advancement device 112. In another embodiment, the upstream pressurized fluid source may be a subsequent advancement device 124 that is upstream of the advancement device 112. The transmission line 110 then travels through an air block 802A and transmission line counter assembly 192 where it enters and travels through the advancement device drive assembly 150 toward the outlet 186. As the transmission line 110 travels toward the outlet 186, it is guided past the transmission line sensor 560, wherein the transmission line sensor 560 is positioned at a position downstream of the actuator 166. This operation is illustrated and described in further detail with respect to FIG. 9. In some embodiments, the transmission line sensor 560 is positioned downstream of the advancement device drive assembly 150.

In a third operation 476, the transmission line sensor 560 senses the presence of the transmission line 110. In some embodiments, the transmission line sensor 560 includes a light emitter and detector configured to emit light and detect a drop in voltage at a light sensor, for example, when the light is blocked by the transmission line 110. In some embodiments, the light emitter is configured to emit infrared light or visible light. This operation is illustrated and described in further detail with respect to FIG. 2.

In a fourth operation 478, the transmission line sensor 560 communicates the presence of the transmission line 110 to the actuator 166 via the local controller 160, wherein the local controller 160 is configured to receive a signal or message from the transmission line sensor 560, process the signal, and provide an instruction to other components 340 within the advancement device 112. This operation is illustrated and described in further detail with respect to FIGS. 3-12.

In a fifth operation 480, the local controller 160 provides an instruction to the advancement device drive assembly 150, and specifically the actuator 166, to frictionally engage the transmission line 110 to advance the transmission line 100. In some embodiments, the advancement device drive assembly 150 includes a tractor drive assembly 152 configured to frictionally engage the transmission line 110. This operation is illustrated and described in further detail with respect to FIGS. 3-12.

In a sixth operation 482, the advancement device drive assembly 150, and specifically the tractor drive assembly 152, advances the transmission line 110 toward an outlet 186 positioned at a second end 712 of the advancement device 112. The outlet 186 is configured to guide the transmission line 110 and pressurized fluid into a conduit C as illustrated and described in FIGS. 5-7, and 9.

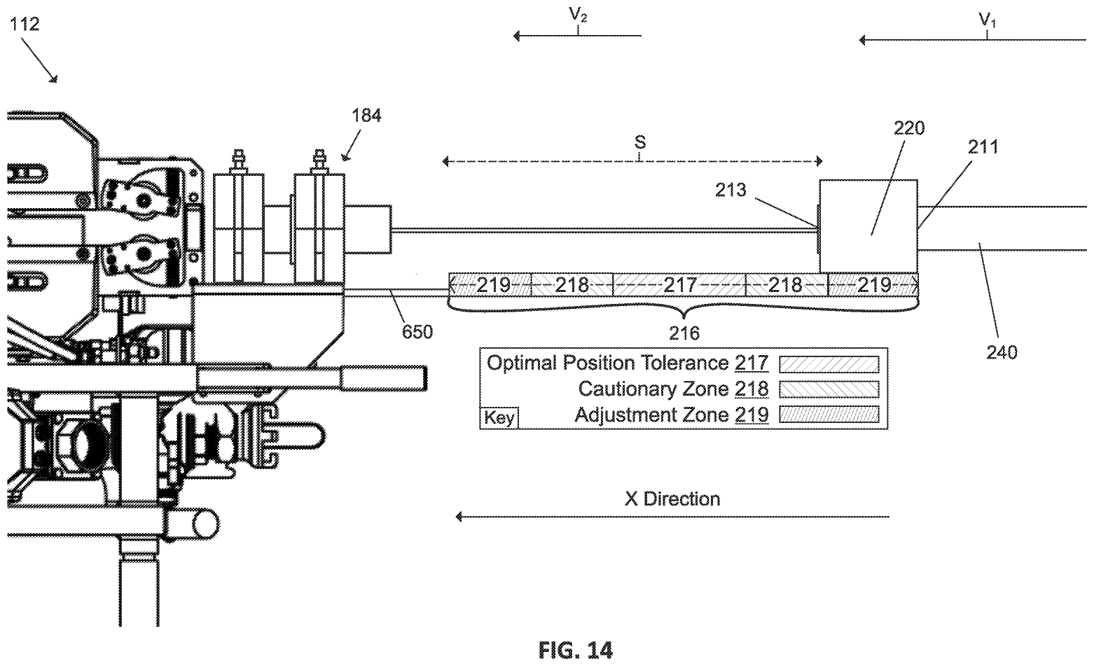

FIG. 14 is a side view of an example advancement device 112 including a speed measurement device 220, wherein the speed measurement device 220 is in an extended position. In embodiments, the speed measurement device 220 is a speed block. The speed block may be a movable member that can move from an extended position to a shortened position, and a variety of positions there between. The speed measurement device 220 is allowed to move freely, or slide, in one dimension in an x direction and a negative x direction (together the x axis). The speed measurement device 220 may slide along a base 650 (such as a rail) when the transmission line 110 speed at the first location is unequal to the transmission line 110 speed at the second location. This is illustrated in FIG. 14 with different velocities of the transmission line V₁, V₂ that are present at a speed measurement device first end 211 or a speed measurement device second end 213.

The first velocity V₁ measures the velocity of the transmission line 110 as it approaches the speed measurement device first end 211 from an incoming conduit segment 240. In certain embodiments, if the speed measurement device 220 is located at a first subsequent advancement device 124 in a transmission line installation system 100, the first velocity V₁ may be dependent upon the speed at which an initial advancement device 122 retrieves a transmission line 110 from a transmission line source 102 and advances the transmission line 110 to the subsequent advancement device 124. In certain embodiments, if the speed measurement device 220 is located downstream of the first subsequent advancement device 124 in the transmission line installation system 100, then the first velocity V₁ may be dependent upon the speed at which an initial advancement device 122 retrieves the transmission line 110 from the transmission line source 102 and the speed at which any upstream subsequent advancement devices 124 receive advance the transmission line 110.

The second velocity V₂ measures the velocity of the transmission line 110 as it exits the speed measurement device 220 at the speed measurement device second end 213 and is advanced by an advancement device 112 located downstream of the speed measurement device 220. The advancement device 112 that is located downstream of the speed measurement device 220 may not be synchronized to advance the transmission line 110 at the same speed as advancement devices 112 that are located upstream of the speed measurement device 220. Thus, in certain examples, the second velocity V₂ is not equal to the first velocity V₁. When this occurs, the speed measurement device 220 will move in the direction of the greater speed (e.g., if the first speed V₁ is greater than the second speed V₂ as shown in FIG. 14, then the speed measurement device 220 will move toward the incoming conduit segment 240, or vice-versa). It is desirable to have the first velocity V₁ and the second velocity V₂ approximately equal because it prevents damage to the transmission line 110 that occurs when the transmission line 110 is stretched or coiled.

In some embodiments, the speed measurement device 220 may include at least one sensor. In a particular embodiment, the sensor may be located within the speed measurement device 220. In another embodiment, the sensor may be part of the speed measurement device sensor 216. In some embodiments the at least one sensor is a position sensor. In embodiments, the sensor may be placed along the speed measurement device 220 and it senses the movement of the speed measurement device 220 as it slides a distance S. The positional sensors may then communicate with a local controller 160 to adjust the speed of the transmission line 110 until the position of the speed measurement device 220 is an optimal distance from the inlet 184.

The speed measurement device sensor 216 may measure the movement of the speed measurement device 220 along a base 650, which may be an x-axis. The speed measurement device sensor 216 may include a manual reader configured to be read by a user operating the transmission line installation system 100 or it may be configured to operate automatically using one or more sensors 216. The sensor(s) may include a speed measurement device sensor 216 configured to read a change of position in the speed measurement device 220 along the x axis. In certain embodiments, the speed measurement device sensor 216 may include an optical sensor, a mechanical sensor, a potentiometer, a linear position sensor, a rotary position sensor, an angular position sensor, an inductive position sensor, an ultrasonic position sensor, a magnetostrictive position sensor, a capacitive position sensor, a fiber-optic position sensor, or any other position sensor otherwise identifiable by a person of ordinary skill in the art. The sensor(s) may be configured to measure a position of the speed measurement device 220 based on a slide distance S measured from the speed measurement device second end 213 to the inlet 184. The sensor(s) may be further configured to communicate the slide distance S to the advancement device 112 located downstream of the speed measurement device 220. The advancement device 112 receives this communication via a local controller 160, which can then adjust the second velocity V₂ by adjusting the speed of the upper and lower tractor drive 154, 156 within the advancement device 112. In certain embodiments, additional advancement devices 112 located upstream of the speed measurement device 220 within the transmission line installation system 100 may be adjusted by communicating the speed of the tractor drives 154, 156 of each advancement device 112 via the local controllers 160 and a control unit 120. Communication between multiple advancement devices 112 via local controller 160 and a control unit 120 is further illustrated and described herein with reference to FIG. 8.

In embodiments, the speed measurement device 220 determines and communicates V₁, V₂. In other embodiments, the speed measurement device sensor 216 determines and communicates V₁, V₂. In some embodiments, the speed measurement device 220 and the speed measurement device sensor 216 work together to determines and communicates V₁, V₂.

The speed measurement device sensor 216 may also be configured to be read manually by a user positioned along the transmission line installation system 100. In certain embodiments, the speed measurement device sensor 216 may include an optimal position tolerance 217 (indicated with wide diagonal upper right to lower left shading) where the speed measurement device 220 is positioned on the speed measurement device sensor 216 such that the first velocity V₁ and the second velocity V₂ are equal or are within an allowable tolerance where damage to the transmission line 110 is unlikely to occur.

In certain embodiments, the speed measurement device sensor 216 may include a cautionary zone 218 (indicated with wide diagonal upper left to lower right shading) positioned on both ends of the optimal position tolerance 217. The cautionary zone 218 provides an indication to the user that a manual adjustment may be made but is not always required. The speed measurement device 220 may slide into the cautionary zone 218 by either shortening or extending the incoming conduit segment 240. When the speed measurement device 220 is in the cautionary zone 218, the user may manually adjust the second velocity V₂ by adjusting the speed of the upper and lower tractor drive 154, 156 in the advancement device 112 located upstream of the speed measurement device 212. As the second velocity V₂ is adjusted, the position of the speed measurement device 220 will correspondingly adjust. An increase in the second velocity V₂ will move the speed measurement device 220 in the positive x direction (as denoted in this Figure by an arrow) and a decrease in the second velocity V₂ will move the speed measurement device 220 in the negative x direction. As shown in this figure, the user may adjust the speed measurement device 220 from its extended position back to the optimal position tolerance 217 by increasing the second velocity V₂. Furthermore, the first velocity V₁ may be also adjusted at the first location to synchronize the first velocity V₁ and the second velocity V₂. In a particular embodiment, the speed measurement device 220 may be a slide block.

In certain embodiments, the speed measurement device sensor 216 may include an adjustment zone 219 (indicated with narrow diagonal upper right to lower left shading) positioned on both ends of the cautionary zone 218 (indicated with wide diagonal upper left to lower right shading). In a particular embodiment, there may be a color-coded visual indication of the status for the speed measurement device 220. For example, optimal position tolerance 217 may be indicated in green, the cautionary zone 218 may be indicated in yellow, and the adjustment zone 219 may be indicated in red. Embodiments of this color-coded system are depicted in FIGS. 14-16. These are just examples of colors and in different embodiments, different colors may be used.

As shown in FIG. 14, the speed measurement device 220 is in the adjustment zone 219 in an extended configuration. The adjustment zone 219 provides an indication to the user that a manual adjustment is required to prevent damage to the transmission line 110. The speed measurement device 220 may slide into the adjustment zone 219 by either shortening or extending the incoming conduit segment 240. When this occurs, the user may manually adjust the second velocity V₂ by adjusting the speed of the upper and lower tractor drive 154, 156 in the advancement device 112 located downstream of the speed measurement device 220 as described above. In an embodiment, the velocity, or velocities, may be adjusted automatically. A conduit with an adjustable length may be a coupled between the inlet 184 and the speed measurement device second end 213 to guide the transmission line 110 from the speed measurement device second end 213 to the inlet 184.

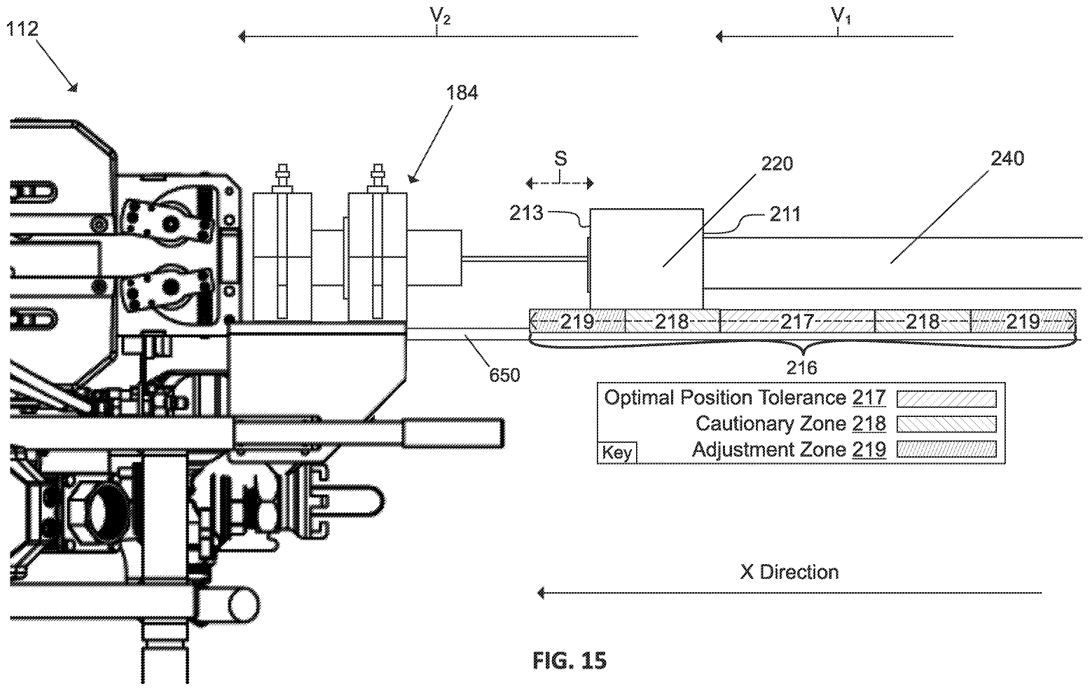

FIG. 15 is a side view of an example advancement device 112 including a speed measurement device 220, wherein the speed measurement device 220 is in a shortened position.

As described herein with reference to FIG. 15, the speed measurement device 212 is shown located between the cautionary zone 218 (indicated with wide diagonal upper left to lower right shading) and the adjustment zone 219 (indicated with narrow diagonal upper right to lower left shading). The position of the speed measurement device 220 may be adjusted to the optimal position tolerance 217 to mitigate damage to the transmission line 110 by adjusting the second velocity V₂. As shown in this Figure, a user would decrease the second velocity V₂ to shift the speed measurement device 220 in the negative x-direction (to the right in the FIG. 15 as shown). The user may make a predetermined adjustment of the second velocity V₂ based on the position of the speed measurement device 220 along the speed measurement device sensor 216 or the user may incrementally adjust the second velocity V₂ until the speed measurement device 220 is positioned within the optimal position tolerance 217. In another possible embodiment, the position of the speed measurement device 220 can be determined automatically by one or more sensors, and the advancement device 112 can automatically adjust the velocity in response.

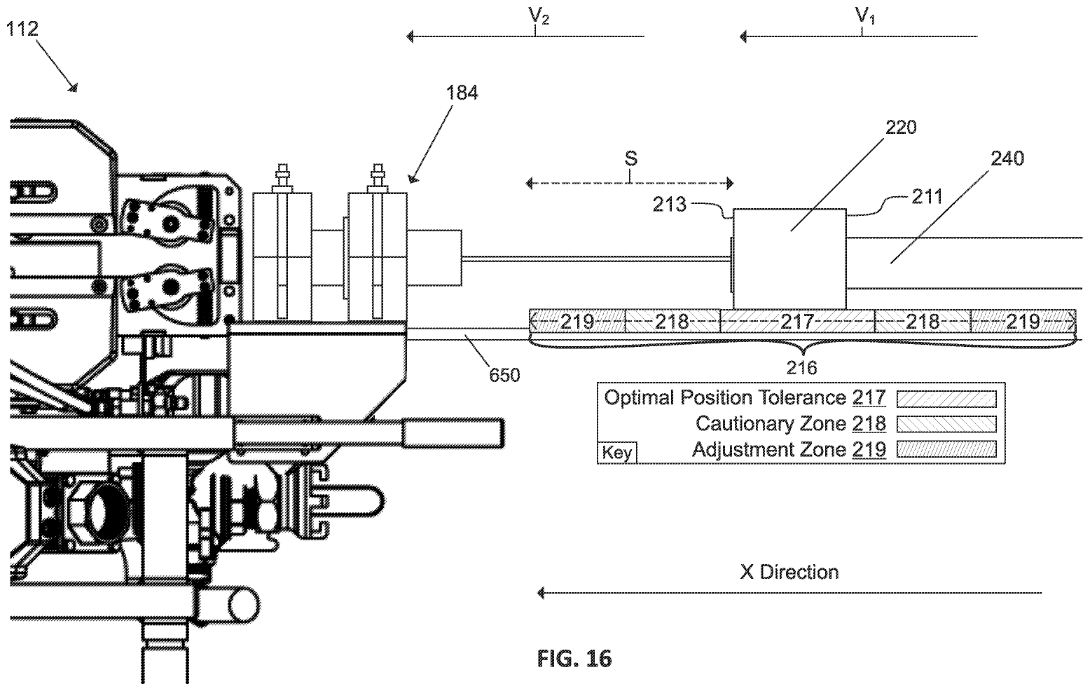

FIG. 16 is a side view of an example advancement device 112 including a speed measurement device 220, wherein the speed measurement device 220 is in the optimal position tolerance 217. As shown in this Figure, the position of the speed measurement device 220 along the speed measurement device sensor 216 indicates the speed measurement device 220 is within the optimal position tolerance 217. When the speed measurement device 220 is within the optimal position tolerance 217, damage to the transmission line 110 is mitigated, and the user need not perform an adjustment at this time.

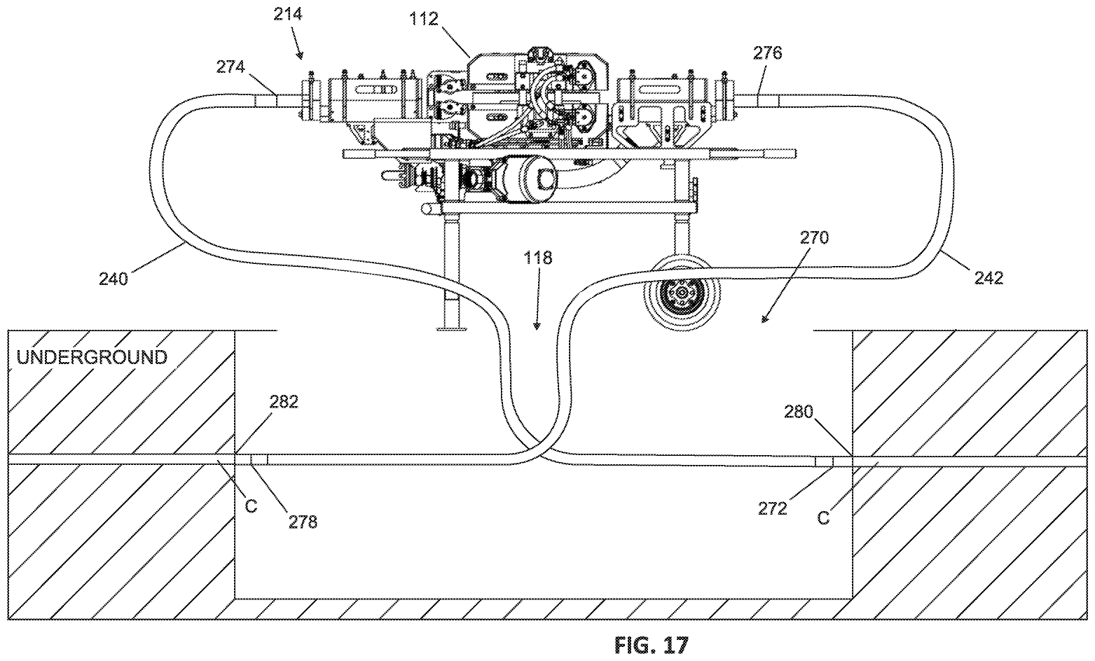

FIG. 17 is a side view of the example advancement device 112 further illustrating various components for transporting a transmission line 110 through a conduit C at an access point 118 within a cascade junction 270. In a particular embodiment a cascade junction 270 may be installed at an access point 118. In some embodiments, the cascade junction 270 includes a transmission line advancement device 112 as well as, for example, two (or more) conduits C connected to the transmission line advancement device 112. For example, the cascade junction 270 can include incoming conduit segment 240 and outgoing conduit segment 242. In the depicted example, the cascade junction 270 includes a conduit having a conduit upstream end 280 and a conduit downstream end 282, a conduit-incoming conduit segment connector 272, an incoming conduit segment 240, an incoming conduit segment-advancement device connector 274, an advancement device 112, an advancement device-outgoing conduit segment connector 276, an outgoing conduit segment 242, and an outgoing conduit segment-conduit connector 278, wherein each component of the cascade junction 270 is positioned at an access point 118. In certain embodiments, the conduit upstream end 280 and the conduit downstream end 282 may align in three-dimensional space such that a direction of travel of the transmission line 110 through the conduit C from the conduit upstream end 280 to a conduit downstream end 282 only occurs in one dimension.

The conduit-incoming conduit segment connector 272 is configured to couple the incoming conduit segment 240 to the conduit C at a conduit upstream end 280 and guide the transmission line 110 from the conduit C to the incoming conduit segment 240.

The incoming conduit segment 240 is configured to guide the transmission line 110 to an incoming conduit segment-advancement device connector 274.

The incoming conduit segment-advancement device connector 274 is configured to couple the incoming conduit segment 240 to the advancement device 112 and guide the transmission line 110 from the incoming conduit segment 240 into the advancement device 112 at the inlet 184, (or in some embodiments, to the speed measurement device 220, such as shown in FIG. 14) which includes a lead-in guide 214.

The advancement device-outgoing conduit segment connector 276 is configured to couple the advancement device 112 to the outgoing conduit segment 242 and guide the transmission line 110 from the advancement device 112 to the outgoing conduit segment 242.

The outgoing conduit segment 242 is configured to guide the transmission line 110 to the outgoing conduit segment-conduit connector 278.

The outgoing conduit segment-conduit connector 278 is configured to guide the transmission line from the outgoing conduit segment 242 to the conduit C at a conduit downstream end 282.

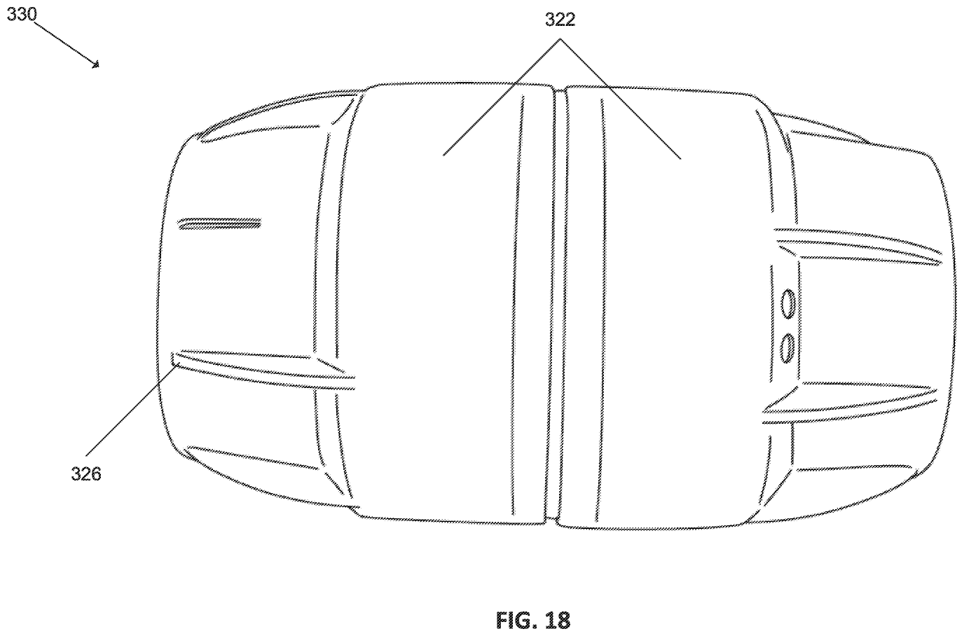

FIG. 18 is a side view of an example connector 320 that is configured to couple to the incoming conduit segment 240, the outgoing conduit segment 242, to the advancement device 112, or a conduit C. In some embodiments, the connector 320 may be used within a cascade junction 270 as a conduit-incoming conduit segment connector 272, an incoming conduit segment-advancement device connector 274, an advancement device-outgoing conduit segment connector 276, or an outgoing conduit segment-conduit connector 278.

In some embodiments, the connector 320 includes two end nuts 322 that couple to a central segment. In some embodiments, the end nuts 322 include internal threads that couple to the central segment using a threaded connection. Furthermore, in some embodiments, the connector 320 includes a grip ring coupled to an end nut 322 that is configured to fit around a conduit C or other object. In some embodiments, the grip ring fits around a conduit C or other object using an interference fit. In some embodiments, the connector 320 includes a hermetic seal, such as an O-ring. In some embodiments, the connector 320 is composed of a plastic material such as high-density polyethylene (HDPE). A plastic material, such as HDPE, is desirable because it is resistant to corrosion while having desirable insulative properties. In some embodiments, the connector 320 includes a tapered design with ridges 326 to allow a user to twist the end nuts 322 without tools. In some embodiments, the connector 320 includes a compact design that is configured to be used within limited-access areas such as access points 118. These access points 118 may include pull boxes, vaults, narrow trenches, or other underground spaces.

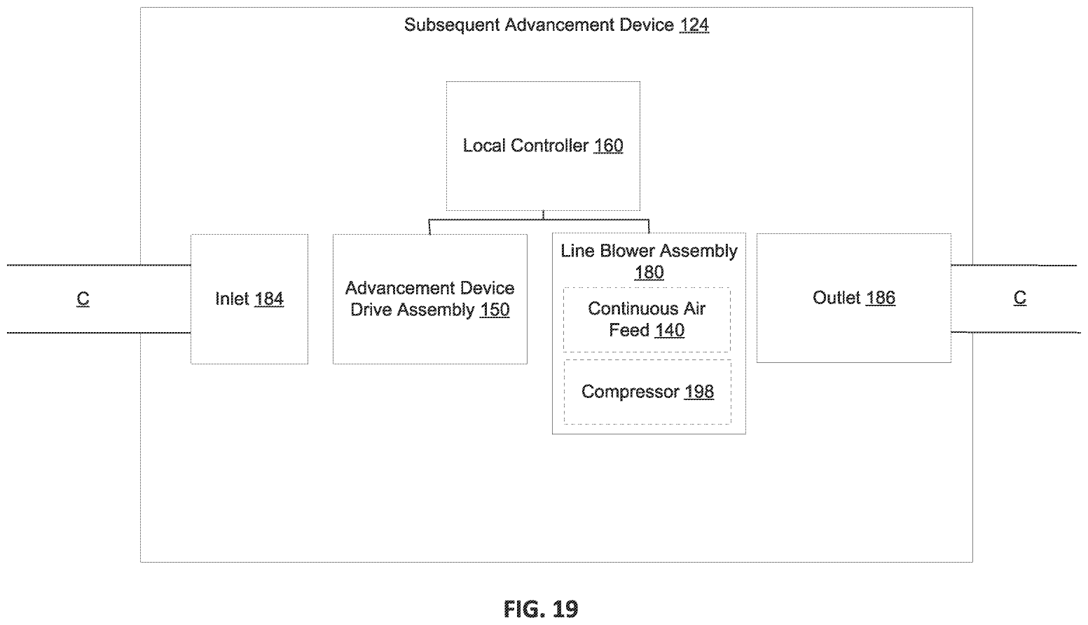

FIG. 19 is a block diagram illustrating various components of a subsequent advancement device 124 including a continuous air feed 140 and a compressor 198.

In some embodiments, the continuous air feed 140 is included within the line blower assembly 180. The continuous air feed 140 is located downstream of an inlet 184. When the advancement device 112 receives a transmission line 110 at the inlet 184, the transmission line 110 is advanced into the advancement device drive assembly 150. A seal is placed within the inlet 184 that allows the transmission line 110 to pass into the advancement device drive assembly 150 while guiding pressurized fluid from a previous advancement device 112 within a transmission line installation system 100 to the continuous air feed 140. If a force from the pressurized fluid from a previous advancement device 112 is insufficient to continue advancing the transmission line 110 along the transmission line installation system 100, then an additional force from a compressor 198 may be introduced at the continuous air feed 140 to continuously advance the transmission line 110 within the transmission line installation system 100. In some embodiments, a sensor may be used to automatically measure the pressure at the continuous air feed 140 and communicate that pressure to the local controller 160, wherein the local controller 160 then engages the compressor 198 to release pressurized fluid into the continuous air feed 140. In some embodiments, a user may manually release pressurized fluid from the compressor 198 into the continuous air feed 140 if a pressure sensor indicates a pressure that is insufficient to advance the transmission line 110 within the transmission line installation system 100.

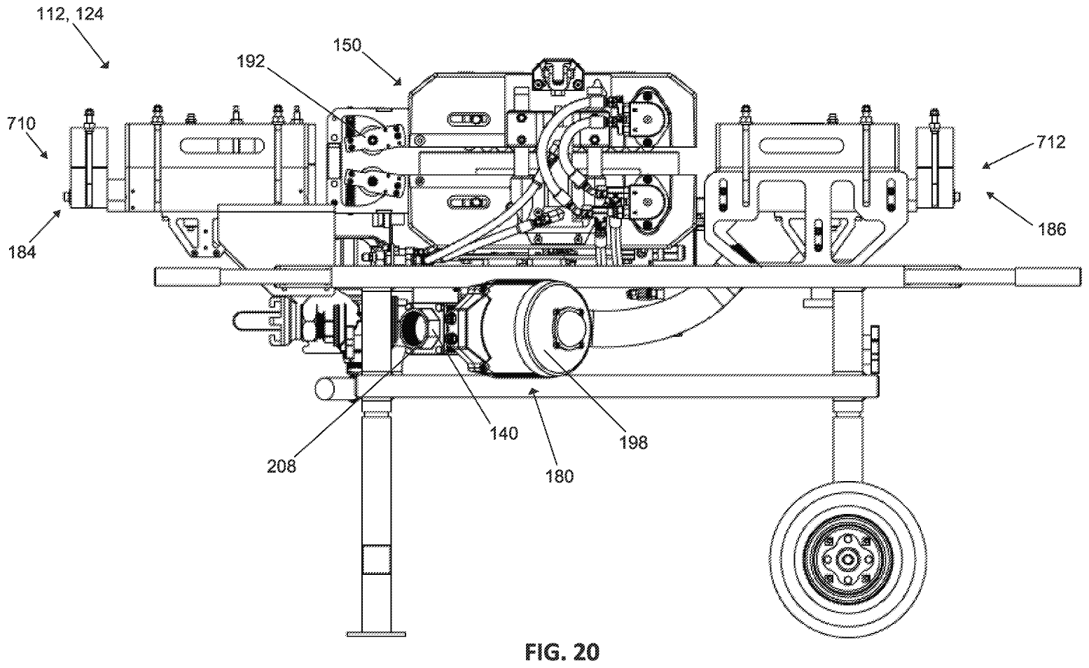

FIG. 20 is a side view illustrating the components of FIG. 19, including the continuous air feed 140 and compressor 198. In some embodiments, the continuous air feed 140 and compressor 198 are included within the advancement device 112 at a cascade junction 270. In embodiments, the transmission line 110 may advance from the first end of the advancement device 710 to the second send of the advancement device 712. The continuous air feed 140 and a compressor 198 may apply an additional force within the line blower assembly 180 as illustrated and described in FIG. 20.

One or more features from any embodiment may be combined with one or more features of any other embodiment without departing from the scope of the invention.

1. An advancement device for advancing a transmission line within a transmission line installation system comprising:
a local controller operable to locally control the advancement device, the local controller comprising a processing device, a computer-readable storage device, and a communication device;
an advancement device drive assembly operably coupled to the local controller, the advancement device drive assembly configured to receive the transmission line from a transmission line source and advance the transmission line from an inlet to a line blower assembly;
the line blower assembly operably coupled to the local controller, the line blower assembly configured to receive the transmission line from the advancement device drive assembly and advance the transmission line to an outlet; and
a transmission line sensor configured to sense a presence of the transmission line, wherein the local controller is configured to instruct the advancement device drive assembly to frictionally engage the advancement device drive assembly with the transmission line when the transmission line sensor senses the presence of the transmission line.

2. The advancement device of claim 1, wherein the advancement device drive assembly is configured to frictionally engage the transmission line with a tractor drive, wherein the tractor drive is configured to frictionally engage the transmission line using an actuator.

3. The advancement device of claim 1, wherein the transmission line source is a transmission line reel configured to supply the transmission line to the advancement device.

4. The advancement device of claim 1, wherein the transmission line source is an upstream advancement device that is configured to supply the transmission line to a downstream advancement device within the transmission line installation system.

5. The advancement device of claim 2, wherein the tractor drive further comprises an upper tractor drive and a lower tractor drive.

6. The advancement device of claim 5, wherein the actuator further comprises a clamp cylinder configured to provide a normal force to the lower tractor drive to frictionally engage the upper tractor drive and the lower tractor drive with the transmission line.

7. (canceled)

8. (canceled)

9. (canceled)

10. The advancement device of claim 2, wherein the actuator is electrically, hydraulically, or pneumatically powered.

11. The advancement device of claim 1, wherein the transmission line sensor further comprises an optical sensor configured to read markings on an exterior of the transmission line as it passes through the line blower assembly.

12. The advancement device of claim 11, wherein the optical sensor includes a light emitter and detector configured to emit light and detect a drop in voltage at a light sensor when the light is blocked by the transmission line.

13. The advancement device of claim 12, wherein the light is infrared light and the light emitter is configured to emit infrared light and detect the drop in voltage at the light sensor when infrared light is blocked by the transmission line.

14. The advancement device of claim 12, wherein the light is visible light and the light emitter is configured to emit visible light and detect the drop in voltage at the light sensor when visible light is blocked by the transmission line.

15. The advancement device of claim 1, wherein the transmission line sensor further comprises an electric sensor or a mechanical sensor.

16. The advancement device of claim 1, wherein the transmission line sensor further comprises a mechanical sensor.

17. The advancement device of claim 11, wherein the transmission line sensor is configured to calculate a speed of the transmission line by reading the markings on the exterior of the transmission line and calculating a number of markings that pass per unit of time, wherein the markings are separated from one another by a predetermined distance.

18. The advancement device of claim 17, wherein the advancement device is one of a plurality of advancement devices each including the local controller configured to communicate the speed of the transmission line using a global controller that receives information from the local controllers.

19. The advancement device of claim 18, wherein the global controller is configured to process the speed of the transmission line from the local controllers and communicate a synchronized speed to each of the local controllers.

20. The advancement device of claim 19, wherein the local controllers are configured to control the advancement device drive assembly to advance the transmission line at the synchronized speed.

21. The advancement device of claim 2, wherein the actuator further comprises a proximity switch configured to measure a position of the tractor drive.

22. A method for advancing a transmission line using an advancement device comprising:
using a transmission line source, providing the transmission line to the advancement device at an inlet positioned at a first end of the advancement device;
using the inlet, receiving the transmission line and guiding the transmission line to a transmission line sensor;
using the transmission line sensor, sensing the transmission line at a position downstream of an advancement device drive assembly;
using a local controller operably coupled to the advancement device drive assembly and the transmission line sensor, communicating a presence of the transmission line at the transmission line to an actuator configured to frictionally engage the advancement device drive assembly with the transmission line to advance the transmission line; and
using the advancement device drive assembly, advancing the transmission line toward an outlet positioned at a second end of the advancement device.

23. (canceled)

24. (canceled)

25. The method for advancing the transmission line using an advancement device of claim 22, wherein the transmission line sensor is an optical sensor that reads markings on an exterior of the transmission line as it passes the position downstream of the advancement device drive assembly.

26. The method for advancing the transmission line using an advancement device of claim 22, wherein the transmission line sensor is an optical sensor configured to emit a light and detect a drop in voltage when the light is blocked by the transmission line.

27. (canceled)

28. (canceled)

29. (canceled)

30. (canceled)

31. (canceled)
